(19) United States
(12) Patent Application Publication
(10) Pub. No.: US 2015/0149536 A1
(43) Pub. Date: May 28, 2015

(54) NETWORK SYSTEM, CONSTANT CONNECTION METHOD, COMMUNICATION METHOD, ELECTRONIC DEVICE, CONSTANT CONNECTION SERVER, APPLICATION SERVER, AND PROGRAM

(71) Applicant: SHARP KABUSHIKI KAISHA, Osaka (JP)

(72) Inventors: Hitoshi NISHIKAWA, Osaka (JP); Hirofumi FURUKAWA, Osaka (JP); Akira TOJIMA, Osaka (JP); Kayo MORINAGA, Osaka (JP); Makoto SAKUTA, Osaka (JP)

(21) Appl. No.: 14/555,651

(22) Filed: Nov. 27, 2014

(30) Foreign Application Priority Data
Nov. 27, 2013 (JP) 2013-244544
Nov. 27, 2013 (JP) 2013-244545

(51) Int. Cl. H04L 29/06; H04L 29/08

(52) U.S. Cl. CPC H04L 67/42; H04L 67/10
USPC 709/203; 709/217; 709/219

(57) ABSTRACT

A network system is provided that includes a first and a second electronic device. The first and second electronic devices perform data communications by using a first protocol that enables a constant connection, and perform data communications by using a second protocol when a predetermined condition is satisfied. Alternatively, a network system is provided that includes an electronic device; a constant connection server that makes a constant connection with the electronic device; and an application server that sends data to the electronic device in response to polling from the electronic device. The application server pushes a polling instruction to the electronic device via the constant connection server.

### BACKGROUND OF THE INVENTION

1. Field of the Invention

The present invention relates to techniques for the constant connection of electronic devices, particularly to a network system for the constant connection of client and server, a constant connection method, an electronic device, a constant connection server, an application server, and a program. Alternatively, the present invention relates to techniques for sending and receiving data between client and server, particularly to a network system that sends and receives data over a constant connection, and to a communication method, an electronic device, an application server, and a program.

2. Description of the Related Art

Various techniques for mutually sending data between communications devices are known. For example, JP-A-2010-277492 (Patent Literature 1) discloses an electronic conference server and computer programs. This disclosure is intended to provide real-time processing for an electronic conference system running on web applications, and to manage unsolved problems associated with the operation of an electronic conference system, among others. Specifically, an application server controls a Comet server so that the Comet server remains on hold even with an HTTP request sent from electronic devices. Upon receiving message data from any of the electronic devices, the application server retrieves the necessary data from a conference database, and sends the data to the electronic device of interest via the Comet server, together with the message data. After the data transmission, the application server puts the Comet server on hold again for any incoming HTTP request from electronic devices.

However, because Comet requires a new HTTP session for each communication, the same data needs to be exchanged multiple times between client and server. The WebSocket technology, a protocol that runs on TCP (Transmission Control Protocol), has been developed to overcome this drawback. WebSocket was standardized by internet standards organizations W3C and IETF as a bidirectional communication protocol for web server and web browser. The specification of the WebSocket protocol is described in RFC (Request For Comment) 6455.

However, sending and receiving of large data over a WebSocket constant connection involves the possibility of occupying the communication path of the constant connection. This may delay the delivery of important data to a server or a client.

A technique is available that allows a server to send and receive data to and from a client in response to polling from client side.

JP-A-2009-130438 (Patent Literature 2) discloses a technique related to polling, specifically a data communication device, a data communication device control method, a data communication device control program, and a computer-readable storage medium storing the program. The portable communication terminal described in this publication includes an event detecting unit for detecting an event as it occurs in the device, a polling information database that stores a polling interval associated with an event, a polling setting unit that obtains from the polling information database the polling interval associated with the event detected by the event detecting unit, and changes the polling interval for a predetermined time period, and an e-mail obtaining unit that performs polling for a predetermined time period at the polling interval changed by the polling setting unit. This reduces battery consumption, and enables obtaining data at the optimum polling interval for a user.

JP-A-2013-172519 (Patent Literature 3) discloses a power control device, a communication control method, and a communication control program. According to this publication, the control unit (communication control unit) of the power control device queries each power feeding unit, and obtains the status of the power feeding unit. The control unit refers to the status of the power feeding unit, predicts the communication frequency necessary for controlling the power feeding unit, and sets the query time period (polling interval) so that the time until the next query by the control unit becomes shorter for power feeding units requiring higher communication frequencies. The control unit updates the polling interval for each query.

However, pushing of data from server to client is not possible until the polling is performed. This can be overcome by the recently developed WebSocket constant connection technology.

However, while the WebSocket allows pushing of data from server to client at any timing, it is not always the case that all the clients in a network system accommodate WebSocket.

### SUMMARY OF INVENTION

The present invention has been made to provide solutions to the foregoing problems, and it is an object of the present invention to provide a network system with which the possibility of occupying the communication path of a constant connection can be reduced. The invention is also intended to provide a constant connection method, an electronic device, and a program. Alternatively, the present invention is intended to provide a network system that enables communications between a constant-connection compatible client and server over a constant connection while allowing a constant-connection incompatible client and server to communicate with each other in a manner as typically performed in the art. The invention is also intended to provide a communication method, an electronic device, an application server, and a program.

According to some aspects of the invention, there is provided a network system that includes a first electronic device and a second electronic device. The first electronic device and the second electronic device perform data communications by using a first protocol that enables a constant connection, and perform data communications by using a second protocol when a predetermined condition is satisfied.

Preferably, the first electronic device is a server, and the second electronic device is a client, and the server determines whether the predetermined condition is satisfied for sending of data to the client.

Preferably, the server sends the client information indicative of a storage location of sending data by using the first protocol when the predetermined condition is satisfied, and the client downloads the data from the storage location by using the second protocol.

Preferably, the server by using the first protocol sends the client a transaction ID for specifying sending of data to the client, the client sends the transaction ID to the server when downloading the data from the storage location, and the server by using the transaction ID notifies a different server of the completion of the download.

Preferably, the first electronic device is a server, and the second electronic device is a client, and the client determines whether the predetermined condition is satisfied for sending of data to the server. Preferably, the client receives information indicative of a destination of the data from the server by using the first protocol, and uploads the data to the destination by using the second protocol when the predetermined condition is satisfied.

Preferably, the client by using the first protocol sends the server a transaction ID for specifying sending of data to the server, the client sends the transaction ID to the server when uploading the data to the destination, and the server by using the transaction ID notifies a different server of the completion of the upload.

Preferably, the predetermined condition is satisfied when the size or volume of transmitted data is above a predetermined value.

Preferably, the predetermined condition is satisfied when a communication speed is below a predetermined value.

Preferably, the predetermined condition is satisfied when the time required for sending data is above a predetermined value.

Preferably, the predetermined condition is satisfied when the frequency of data transmission and reception over the first protocol is above a predetermined value.

According to another aspect of the invention, there is provided a constant connection method that includes:

a first and a second electronic device performing data communications over a first protocol that enables a constant connection;

either of the first and second electronic devices determining whether a predetermined condition is satisfied; and

the first and second electronic devices performing data communications over a second protocol when the predetermined condition is satisfied.

According to another aspect of the invention, there is provided an electronic device that includes:

a communication interface;

a memory that stores a predetermined condition; and

a processor that performs data communications via the communication interface by using a first protocol that enables a constant connection, and that perform data communications via the communication interface by using a second protocol when the predetermined condition is satisfied.

According to another aspect of the invention, there is provided a program for use in an electronic device that includes a processor, a memory, and a communication interface. The program causes the processor to perform data communications via the communication interface over a first protocol that enables a constant connection, determine whether a predetermined condition is satisfied, and perform data communications via the communication interface over a second protocol when the predetermined condition is satisfied.

In this way, the invention can provide a network system that can reduce the possibility of occupying the communication path of a constant connection. The invention also can provide a constant connection method, an electronic device, and a program.

According to another aspect of the invention, there is provided a network system that includes:

an electronic device;

a constant connection server that makes a constant connection with the electronic device; and

an application server that sends data to the electronic device in response to polling from the electronic device.

The application server pushes a polling instruction for the polling of the application server to the electronic device via the constant connection server.

Preferably, the application server determines whether to push the polling instruction to the electronic device via the constant connection server according to a type of a received instruction.

Preferably, the application server pushes the polling instruction to the electronic device via the constant connection server when in receipt of an incoming instruction for immediately starting recording (or when it is desired to immediately start recording), and the application server waits for polling from the electronic device without pushing the polling instruction when in receipt of an incoming instruction for timer recording (or when it is not required to immediately start recording).

Preferably, the application server pushes the polling instruction to the electronic device via the constant connection server when in receipt of an incoming instruction for immediately starting shooting of a picture or a video, and the application server waits for polling from the electronic device without pushing the polling instruction when in receipt of an incoming instruction for timer shooting of a picture or a video.

Preferably, the application server pushes the polling instruction to the electronic device via the constant connection server when sending data concerning a paid service, and the application server waits for polling from the electronic device without pushing the polling instruction when sending data concerning a free service.

Preferably, the application server pushes the polling instruction to the electronic device via the constant connection server when in receipt of an incoming message from a different electronic device, and the electronic device polls the application server and receives the message, and outputs the message.

Preferably, the electronic device includes a camera. Preferably, the application server pushes the polling instruction to the electronic device via the constant connection server when in receipt of an incoming instruction from a different electronic device, and the electronic device polls the application server and receives a shooting instruction from the application server, and takes a picture or a video with the camera.

Preferably, the electronic device has a television program recording function. Preferably, the application server pushes the polling instruction to the electronic device via the constant connection server when in receipt of an incoming instruction from a different electronic device, and the electronic device polls the application server and receives a recording instruction from the application server, and records a television program.

According to another aspect of the invention, there is provided a communication method that includes:

an electronic device opening a constant connection with a constant connection server;

an application server pushing a polling instruction to the electronic device via the constant connection server;

the electronic device polling the application server; and

the application server sending data to the electronic device in response to the polling.

According to another aspect of the invention, there is provided an electronic device that includes:

a communication interface provided for a constant connection with a constant connection server, and for data communications with the application server; and

a processor that, by using the communication interface, receives a polling instruction from the constant connection server, and polls the application server and receives data from the application server.

According to another aspect of the invention, there is provided an application server that includes:

a communication interface provided for communications with a constant connection server and an electronic device; and

a processor that, by using the communication interface, pushes a polling instruction to the electronic device via the constant connection server, and sends data to the electronic device in response to polling from the electronic device.

According to another aspect of the invention, there is provided a program for use in an electronic device that includes a processor and a communication interface. The program causes the processor to open a constant connection with a constant connection server by using the communication interface, receive a polling instruction from the constant connection server by using the communication interface, poll an application server by using the communication interface, and receive data from the application server by using the communication interface.

According to another aspect of the invention, there is provided a program for use in an application server that includes a processor and a communication interface. The program causes the processor to send a polling instruction to an electronic device via a constant connection server by using the communication interface, receive polling from the electronic device by using the communication interface, and send data to the electronic device by using the communication interface.

In this way, the invention can provide a network system that enables communications between a constant-connection compatible client and server over a constant connection while allowing a constant-connection incompatible client and server to communicate with each other in a manner as typically performed in the art. The invention also can provide a communication method, an electronic device, an application server, and a program.

Additional features and advantages of the present disclosure will be set forth in the following detailed description. Alternatively, additional features and advantages will be readily apparent to those skilled in the art from the content of the detailed description or recognized by practicing the subject matter as described herein, including the detailed description, the claims, and the appended drawings. It is to be understood that the foregoing general description concerning the related art and the following detailed description are provided solely for illustrative purposes, and are intended to provide an overview or framework for understanding the nature and character of the inventions as claimed.

### BRIEF DESCRIPTION OF THE DRAWINGS

FIG. 1 is a schematic diagram representing the overall configuration of the network system 1 according to an embodiment.

FIG. 2 is a first schematic diagram briefly representing the operation of opening a constant connection in the network system 1 according to the embodiment.

FIG. 3 is a second schematic diagram briefly representing the operation of opening a constant connection in the network system 1 according to the embodiment.

FIG. 4 is a schematic diagram briefly representing the operation of checking a connection from application server 300 in the network system 1 according to the embodiment.

FIG. 5 is a schematic diagram briefly representing the operation of checking a connection from client 100 in the network system 1 according to the embodiment.

FIG. 6 is a schematic diagram briefly representing the normal information pushing operation from application server 300 in the network system 1 according to the embodiment.

FIG. 7 is a schematic diagram briefly representing the large volume information pushing operation from application server 300 in the network system 1 according to the embodiment.

FIG. 8 is a schematic diagram briefly representing the normal information pushing operation from client 100 in the network system 1 according to the embodiment.

FIG. 9 is a schematic diagram briefly representing the large volume information pushing operation from client 100 in the network system 1 according to the embodiment.

FIG. 10 is a block diagram representing the overall communication configuration of the network system 1 according to the embodiment.

FIG. 11 is a block diagram representing the hardware configuration of client 100 according to the embodiment.

FIG. 12 is a block diagram representing the hardware configuration of constant connection server 200 according to the embodiment.

FIG. 13 is a block diagram representing the hardware configuration of application server 300 according to the embodiment.

FIG. 14 is a block diagram representing the hardware configuration of smartphone 500 according to the embodiment.

FIG. 15 is a sequence diagram representing the data exchange procedures between devices concerning a constant connection in the network system 1 according to the embodiment.

FIG. 16 is a sequence diagram representing details of the procedures for opening a constant connection in the network system 1 according to the embodiment.

FIG. 17 is a sequence diagram representing details of the procedures for closing a constant connection from a client in the network system 1 according to the embodiment.

FIG. 18 is a sequence diagram representing details of the procedures for closing a constant connection from application server 300 in the network system 1 according to the embodiment.

FIG. 19 is a sequence diagram representing details of the procedures for checking a connection from client 100 in the network system 1 according to the embodiment.

FIG. 20 is a sequence diagram representing details of the procedures for checking a connection from application server 300 in the network system 1 according to the embodiment.

FIG. 21 is a sequence diagram representing details of the normal data pushing procedures from application server 300 in the network system 1 according to the embodiment.

FIG. 22 is a sequence diagram representing details of the large volume data pushing procedures from application server 300 in the network system 1 according to the embodiment.

FIG. 23 is a sequence diagram representing details of the normal data pushing procedures from client 100 in the network system 1 according to the embodiment.

FIG. 24 is a sequence diagram representing details of the large volume data pushing procedures from client 100 in the network system 1 according to the embodiment.

FIG. 25 is a schematic diagram representing the WS data structure according to the embodiment.

FIG. 26 is a schematic diagram representing the communication configuration of the network system 1 according to Fifth Embodiment.

FIG. 27 is a schematic diagram representing the communication configuration of the network system 1 according to Sixth Embodiment.

FIG. 28 is a schematic diagram representing the communication configuration of the network system 1 according to Seventh Embodiment.

FIG. 29 is a schematic diagram briefly representing the overall configuration and operation of the network system 1 according to Ninth Embodiment.

FIG. 30 is a flowchart representing details of the procedures of application server 300 in the network system 1 according to Ninth Embodiment.

FIG. 31 is a flowchart representing details of the procedures of client 100 in the network system 1 according to Ninth Embodiment.

FIG. 32 is a schematic diagram briefly representing the overall configuration and operation of the network system 1 according to Tenth Embodiment.

FIG. 33 is a flowchart representing details of the procedures of application server 300 in the network system 1 according to Tenth Embodiment.

FIG. 34 is a flowchart representing details of the procedures of client 100 in the network system 1 according to Tenth Embodiment.

FIG. 35 is a schematic diagram briefly representing the overall configuration and operation of the network system 1 according to Eleventh Embodiment.

FIG. 36 is a flowchart representing details of the procedures of application server 300 in the network system 1 according to Eleventh Embodiment.

FIG. 37 is a flowchart representing details of the procedures of client 100 in the network system 1 according to Eleventh Embodiment.

FIG. 38 is a schematic diagram briefly representing the overall configuration and operation of the network system 1 according to Twelfth Embodiment.

FIG. 39 is a flowchart representing details of the procedures of application server 300 in the network system 1 according to Twelfth Embodiment.

FIG. 40 is a flowchart representing details of the procedures of client 100 in the network system 1 according to Twelfth Embodiment.

### DESCRIPTION OF THE PREFERRED EMBODIMENTS

Embodiments of the present invention are described below with reference to the accompanying drawings. In the following descriptions, like elements are given like reference numerals. Such like elements will be referred to by the same names, and have the same functions. Accordingly, detailed descriptions of such elements will not be repeated.

The following describes WebSocket protocol communications as an example of constant connection. It should be noted, however, that the present invention is in no way limited to a constant connection that uses the WebSocket protocol, as long as an application server and a constant connection server can push data to a client at any timing.

It is also noted that the network system 1 of the following embodiments, described as using the HTTP/WebSocket protocol, may also use the HTTPS/WSS protocol that can encrypt communication channels with SSL. That is, the techniques according to the embodiments of the present invention are also applicable to a network system using the HTTPS/WSS protocol.

### First Embodiment

### Overall Configuration of Network System

The overall configuration of the network system 1 according to the present embodiment is described below. FIG. 1 is a schematic diagram representing the overall configuration of the network system 1 according to the present embodiment.

Referring to FIG. 1, the network system 1 includes a plurality of home appliances 100A and 100B disposed in locations such as homes and offices, a constant connection server 200 connected to the home appliances 100A and 100B via a network, and a plurality of application servers 300A and 300B that provide various services concerning the home appliances 100A and 100B. Examples of the home appliances include a vacuum cleaner 100A, an air conditioner 100B, a television, a washing machine, a refrigerator, a rice cooker, an air purifier, a floor heating system, and an IH (Induction Heating) cooking heater. The home appliances may be any communications devices for homes and offices, including, for example, personal computers, audio-video equipment other than television, and an intercom system. The constant connection server 200 and the application server 300 may include servers that reside in the same home, office, building, company, or school where the home appliances are provided.

The home appliances and each server may be connected to each other via lines such as optical fibers, with an optical network unit, a wireless LAN communication access point, and a router optionally connected in between. The means by which the home appliances are connected to the network is not limited, and may be, for example, wireless LAN communications such as IEEE 802.11a/b/g/n/ac, and wired LAN.

In the present embodiment, the vacuum cleaner 100A and the air conditioner 100B become constantly connected to the constant connection server 200. This enables the application server 300A for vacuum cleaner to push data to the vacuum cleaner 100A at any timing via the constant connection server 200. Likewise, the application server 300B for air conditioner can push data to the air conditioner 100B at any timing via the constant connection server 200.

Specifically, in the network system 1 according to the present embodiment, it is not required to directly establish a constant connection between each home appliance and all the relevant application servers providing services to the home appliances. Conversely, there is no need for each application server to directly establish a constant connection with all the associated home appliances.

In the present embodiment, the constant connection server 200 and the application servers 300A and 300B represent different computers. In other words, the constant connection server 200 runs service programs for establishing constant connections with the home appliances. The programs that run on the application servers 300A and 300B include service programs for controlling the home appliances with the information sent to these devices, and service programs for obtaining information from the home appliances and using this information in other electronic devices.

More than one application service program may be installed in a single application server, as will be described in other embodiment. The constant connection server and the application server may be the same computer. For example, a single computer, specifically a server in the form of a device may contain a communications service program for establishing constant connections with the home appliances, and one or more application service programs for controlling the home appliances.

### <Brief Overview of Network System Operation>

The following is a brief overview of the operation of the network system 1 according to the present embodiment. In the following, the home appliances, including the vacuum cleaner 100A and the air conditioner 100B will also be collectively called clients 100. The term“application server 300” will also be used as a collective term for application servers, including the application server 300A for vacuum cleaner, and the application server 300B for air conditioner, that provide various services to clients 100 and users.

### <Brief Overview of the Operation for Opening Constant Connection>

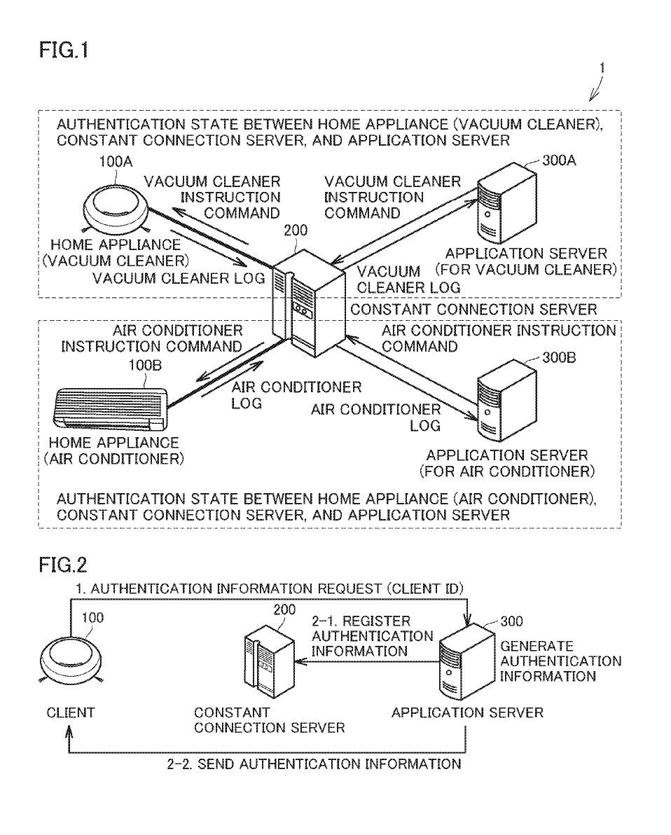

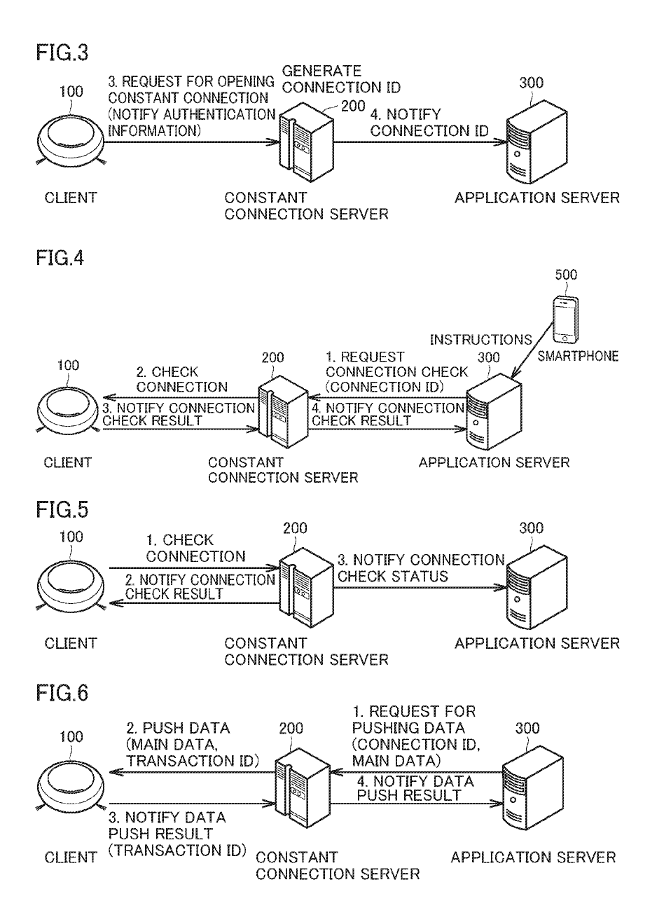

The following is a brief overview of the operation for opening a constant connection in the network system 1. FIG. 2 is a first schematic diagram briefly representing the operation for opening a constant connection in the network system 1 according to the present embodiment. FIG. 3 is a second schematic diagram briefly representing the operation for opening a constant connection in the network system 1 according to the present embodiment.

Referring to FIG. 2, the client 100 requests the application server 300 for authentication information, using the HTTP protocol. In response, the application server 300 generates authentication information, and sends it to the client 100 over the HTTP protocol. The application server 300 also sends the authentication information to the constant connection server 200.

Referring to FIG. 3, the client 100 requests the constant connection server 200 to open a constant connection based on the authentication information, using the HTTP protocol. By using the authentication information from the client 100 and the authentication information from the application server 300, the constant connection server 200 performs an authentication process for the client 100. When authentication is successful, the constant connection server 200 establishes a constant connection with the client 100, using the WebSocket protocol. The constant connection server 200 creates a connection ID unique to the WebSocket connection established between the client 100 and the server 300, and notifies the application server 300 of the connection ID. With the connection ID, the application server 300 is able to push information to the client 100 via the constant connection server 200.

<Brief Overview of the Operation for Checking Connection from Application Server>

The following is a brief overview of the operation for checking a connection from the application server 300. FIG. 4 is a schematic diagram briefly representing the operation for checking a connection from the application server 300 in the network system 1 according to the present embodiment.

Referring to FIG. 4, the application server 300 requests the constant connection server 200 to check the validity (or condition) of the constant connection with the client 100 (e.g., whether the client 100 and the constant connection server 200 are properly operating). In response to the request, the constant connection server 200 sends connection check data to the client 100 over the WebSocket protocol.

Upon receiving the connection check data, the client 100 sends result notification data to the constant connection server 200 over the WebSocket protocol. Upon receiving the result notification data, the constant connection server 200 notifies the application server 300 that the constant connection with the client 100 is valid. On the other hand, when failed to receive the result notification data, the constant connection server 200 notifies the application server 300 that the constant connection with the client 100 is invalid.

The foregoing configuration has use in the following situations. For example, the application server 300 requests the constant connection server 200 for a connection check upon receiving some instruction from a smartphone 500, or when the smartphone 500 displays an instruction entry screen. The application server 300 accepts the instruction for the home appliance only when the constant connection is valid. On the other hand, when the constant connection is invalid, the application server 300 sends notification to a user via the smartphone 500 that the instruction is unexecutable.

<Brief Overview of the Operation for Checking Connection from Client>

The following is a brief overview of the operation for checking a connection from the client 100. FIG. 5 is a schematic diagram briefly representing the operation for checking a connection from the client 100 in the network system 1 according to the present embodiment.

Referring to FIG. 5, the client 100 sends connection check data to the constant connection server 200 over the WebSocket protocol to determine whether the constant connection with the constant connection server 200 is valid. Upon successfully receiving the connection check data, the constant connection server 200 sends result notification data to the client 100 over the WebSocket protocol. Here, the constant connection server 200 also sends notification to the application server 300 that the constant connection with the client 100 is valid.

<Brief Overview of Normal Information Pushing Operation from Application Server>

The following is a brief overview of a normal information pushing operation from the application server 300 to the client 100. FIG. 6 is a schematic diagram briefly representing a normal information pushing operation from the application server 300 in the network system 1 according to the present embodiment.

Referring to FIG. 6, the application server 300 sends the constant connection server 200 a connection ID for specifying the client 100, and main data to be sent to the client 100. The constant connection server 200 determines whether the main data is larger than a predetermined data volume. When the main data is no larger than the predetermined data volume, the constant connection server 200 sends the main data, and a transaction ID for specifying the current data transmission to the client 100 associated with the connection ID, using the WebSocket protocol.

Upon receiving the main data, the client 100 sends result information indicative of the receipt of the main data, and the transaction ID to the constant connection server 200 over the WebSocket protocol. By using the received result information and the transaction ID, the constant connection server 200 notifies the application server 300 of the result of the data transmission.

<Brief Overview of Large Volume Information Pushing Operation from Application Server>

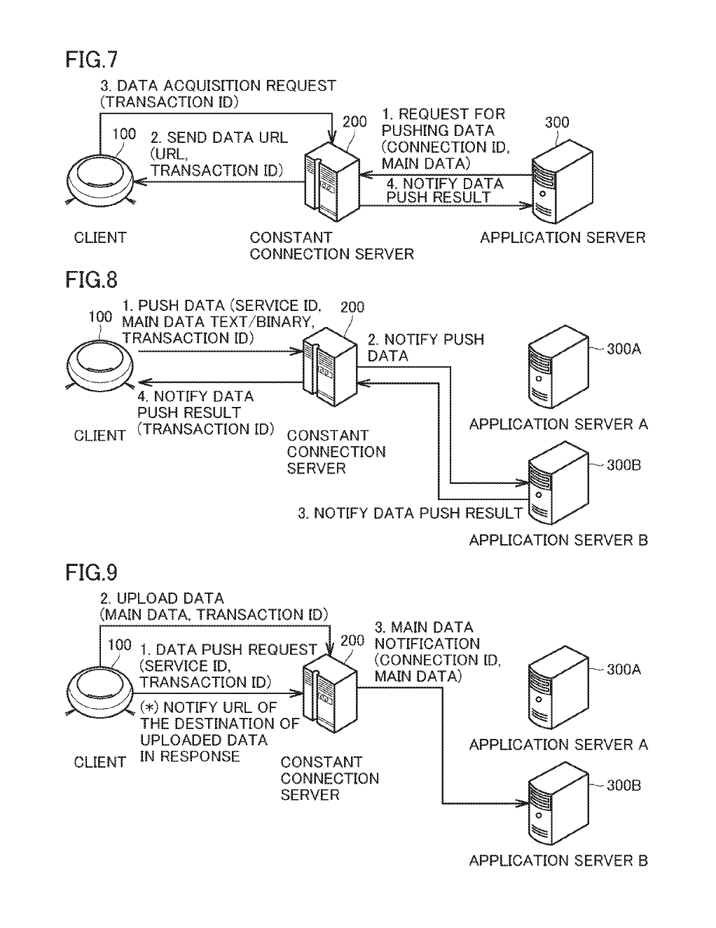

The following is a brief overview of a large volume information pushing operation from the application server 300 to the client 100. FIG. 7 is a schematic diagram briefly representing a large volume information pushing operation from the application server 300 in the network system 1 according to the present embodiment. More specifically, the network system 1 according to the present embodiment has the following functions to prevent large files from occupying the constant connection communications, and to reduce the burden on network resources associated with a constant connection.

Referring to FIG. 7, the application server 300 sends the constant connection server 200 a connection ID for specifying the client 100, and main data to be sent to the client 100. The constant connection server 200 determines whether the main data is larger than a predetermined data volume. When the main data is larger than the predetermined data volume, the constant connection server 200 sends URL information indicative of a data acquisition method, and a transaction ID for specifying the current data transmission to the client 100 associated with the connection ID, using the WebSocket protocol.

Upon receiving the URL information and the transaction ID, the client 100 sends the transaction ID to the constant connection server 200 over the HTTP protocol. By using the transaction ID, the constant connection server 200 sends the main data to the client 100. The client 100 downloads the main data from the storage location associated with the URL information, and sends result information indicative of the receipt of the main data, and the transaction ID to the constant connection server 200. By using the received result information and the transaction ID, the constant connection server 200 notifies the application server 300 of the result of the data transmission.

The determination of data volume may be performed by the application server 300, instead of the constant connection server 200. In this case, the application server 300 sends URL information to the client 100 via the constant connection server 200 when the data volume is larger than the predetermined value. The client 100, using the URL information, downloads data from the constant connection server 200 or the application server 300 over the HTTP protocol.

<Brief Overview of Normal Information Pushing Operation from Client>

The following is a brief overview of a normal information pushing operation from the client 100. FIG. 8 is a schematic diagram briefly representing a normal information pushing operation from the client 100 in the network system 1 according to the present embodiment.

Referring to FIG. 8, the client 100 determines whether the main data to be sent is larger than a predetermined data volume. If it is determined that the main data is no larger than the predetermined data volume, the client 100 sends the constant connection server 200 a service ID for specifying the receiving application server 300, together with main data and a transaction ID for specifying the current data transmission, using the WebSocket protocol.

The constant connection server 200 sends the main data and the associated connection ID of the client 100 to the application server 300B associated with the service ID. Upon receiving the main data, the application server 300B stores the main data in association with the connection ID. The application server 300B then sends result notification indicative of the receipt of the main data to the constant connection server 200. In response to the result notification, the constant connection server 200 sends the transaction ID and the transmission result to the client 100 over the WebSocket protocol.

<Brief Overview of Large Volume Information Pushing Operation from Client>

The following is a brief overview of a large volume information pushing operation from the client 100. FIG. 9 is a schematic diagram briefly representing a large volume information pushing operation from the client 100 in the network system 1 according to the present embodiment.

Referring to FIG. 9, the client 100 determines whether the main data to be sent is larger than a predetermined data volume. When the main data is larger than the predetermined data volume, the client 100 sends the constant connection server 200 a service ID for specifying the receiving application server 300, the data volume, and a transaction ID for specifying the current data transmission, using the WebSocket protocol.

The constant connection server 200 notifies the client 100 of the upload location of the transaction ID and the data over the WebSocket protocol. By using the transaction ID, the client 100 uploads the main data to the upload location over the HTTP protocol.

Upon completion of the upload from the client 100, the constant connection server 200 sends the main data, and the associated connection ID of the client 100 to the application server 300B associated with the service ID. Upon receiving the main data, the application server 300B stores the main data in association with the connection ID. The application server 300B sends result notification indicative of the receipt of the main data to the constant connection server 200. In response to the result notification, the constant connection server 200 sends the transaction ID and the transmission result to the client 100 over the WebSocket protocol.

As described in the foregoing brief overviews of different operations in the network system 1 according to the present embodiment, the client 100 is given a connection ID, and the application server 300, using the connection ID, can push various data to the selected client 100.

In the network system 1 according to the present embodiment, the client 100 and the application server 300 become constantly connected each other via the constant connection server 200. This eliminates the need for exchanging identification ID, and establishing a WebSocket constant connection for each different combination of the client (browser) and the application server (service program). The burden on the network system 1 can thus be reduced from that of related art.

In the network system 1 according to the present embodiment, the client 100 and the constant connection server 200 switch the protocols according to the size of the transmitted data volume, and the communication path using the WebSocket protocol is less likely to be occupied by some of the data sent and received. In other words, it is less likely that sending and receiving of other WebSocket data is obstructed.

The following describes the specific configuration of each component of the network system 1 for realizing the foregoing functions.

### <Network System 1>

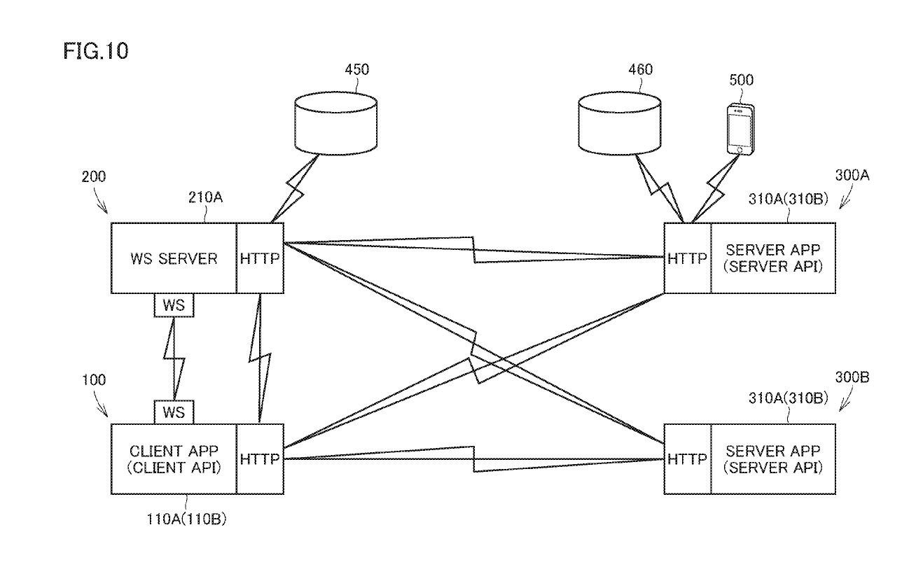

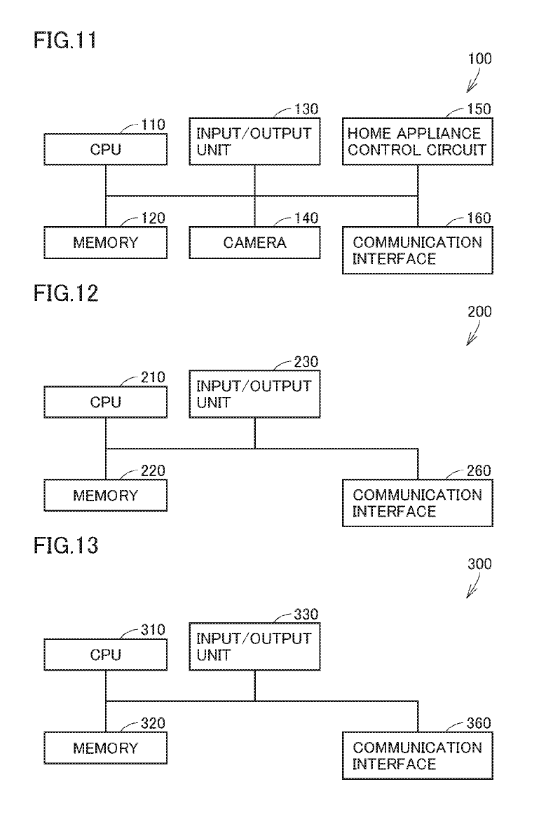

The overall communication configuration of the network system 1 according to the present embodiment is described first. FIG. 10 is a block diagram representing the overall communication configuration of the network system 1 according to the present embodiment.

Referring to FIG. 10, the client 100 may communicate with the constant connection server 200 and the application server 300 over the HTTP protocol, and may constantly connect to the constant connection server 200 over the WebSocket protocol. More specifically, the client 100 contains a client APP 110A and a client API 110B, as will be described later in detail. The client APP 110A controls each part of the client 100. The client API 110B is provided for communications via a communication interface (described later), including communications using the HTTP protocol, and WebSocket protocol communications over the HTTP protocol.

The configuration according to the present embodiment is applicable not only to the HTTP/WebSocket protocol, but to the HTTPS/WSS protocol that can encrypt communication channels with SSL. That is, the network system 1 according to the present embodiment is also applicable to systems based on the HTTPS/WSS protocol.

The constant connection server 200 contains a WS server (constant connection server in the form of software) 210A as a program for controlling the constant connection communications with the client 100 over the WebSocket protocol. The constant connection server 200 may access other database 450, using other protocols. In the present embodiment, the constant connection server 200 can send data to the application server 300 at any timing, using the HTTP protocol.

The network system 1 according to the present embodiment includes a plurality of application servers, 300A and 300B. The application servers 300A and 300B each contain a server APP (application server in the form of software) 310A as a program for providing services to devices such as the client 100 and the smartphone 500, and a server API 310B provided for communicating with the constant connection server 200 over the HTTP protocol.

As an example, the network system 1 includes the application server 300A for controlling the vacuum cleaner 100A, and the application server 300B for controlling the air conditioner 100B. The application servers 300A and 300B may each communicate with the constant connection server 200, other database, the smartphone 500, and other such devices over the HTTP protocol. In the present embodiment, the application servers 300A and 300B can send data to the constant connection server 200 at any timing over the HTTP protocol.

### <Hardware Configuration of Client 100>

The following describes an aspect of the hardware configuration of the client 100. FIG. 11 is a block diagram representing the hardware configuration of the client 100 according to the present embodiment.

Referring to FIG. 11, the main constituting elements of the client 100 include a CPU 110, a memory 120, an input/output unit 130, a camera 140, a home appliance control circuit 150, and a communication interface 160.

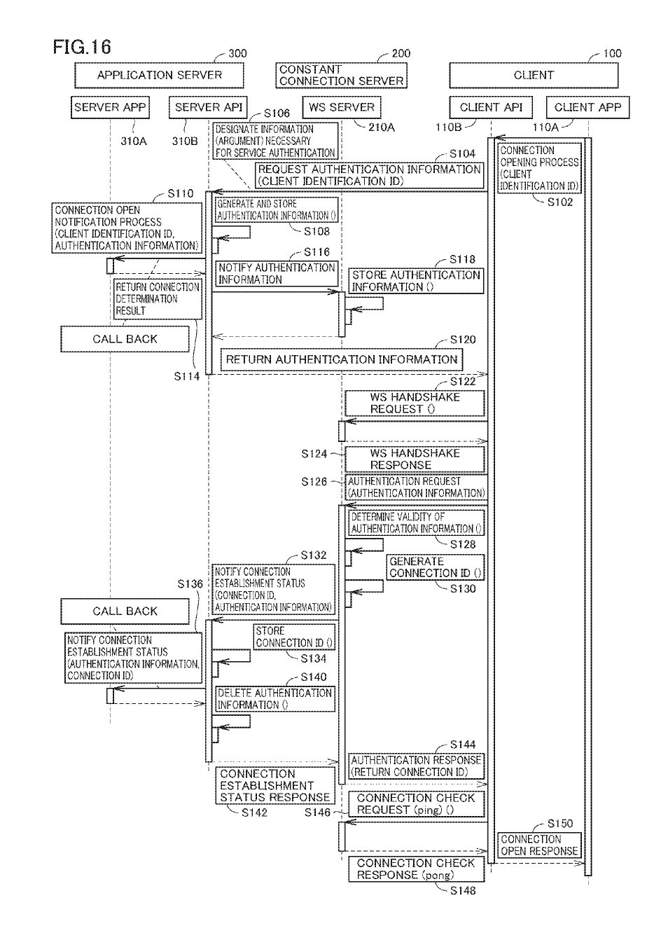

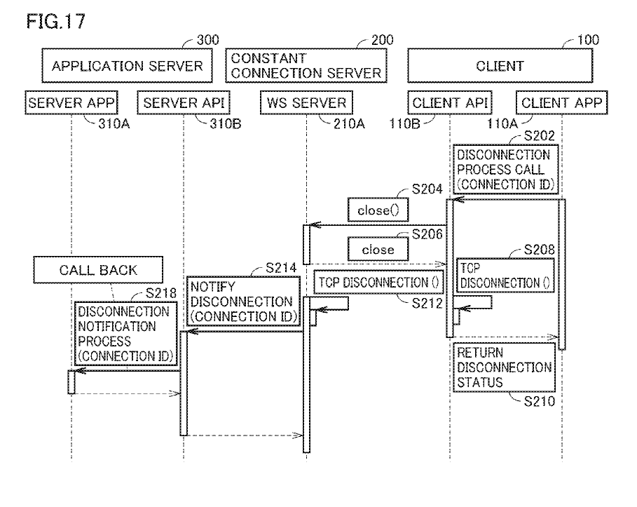

The CPU 110 controls each part of the client 100 by running programs stored in the memory 120 or in external storage media. More specifically, the CPU 110 operates as the client APP 110A (see FIGS. 16 to 24) by using APP (application software) data (described later), and as the client API 110B (see FIGS. 16 to 24) by using API (Application Programming Interface) data (described later). In other words, the CPU 110 performs various processes by running programs stored in the memory 120, as will be described later.

The memory 120 is realized by various types of memory, including, for example, RAM (Random Access Memory), ROM (Read-Only Memory), and flash memory. The memory 120 may also be realized by, for example, storage media used with an interface, including, for example, USB (Universal Serial Bus®) memory, CD (Compact Disc), DVD (Digital Versatile Disk), memory card, hard disk, IC (Integrated Circuit) card, optical memory card, mask ROM, EPROM (Erasable Programmable Read Only Memory), and EEPROM (Electronically Erasable Programmable Read-Only Memory).

The memory 120 stores programs run by the CPU 110, data generated after the execution of a program by the CPU 110, input data via the input/output unit 130, APP data operating as a client such as a vacuum cleaner and an air conditioner, and API data for communicating with the constant connection server 200 while exchanging data with the client APP. Specifically, the memory 120 stores information such as the connected device of the constant connection server, the connected device of the application server, service identification code, service authentication token, connection ID, and client identification ID.

The input/output unit 130 is realized by, for example, a button, a touch panel, or a keyboard. The input/output unit 130 receives a user instruction, and enters the instruction to the CPU 110. The input/output unit 130 is also realized by, for example, a display, or a light, and outputs characters and images by using signals from the CPU 110. The input/output unit 130 is also realized by, for example, a speaker, and outputs sound by using signals from the CPU 110.

The camera 140 takes still pictures and videos by using signals from the CPU 110. Specifically, the camera 140 transfers the captured image data to the CPU 110. The CPU 110 sequentially stores the image data in the memory 120.

The home appliance control circuit 150 controls each part (such as a motor) of the client (home appliance) by using signals from the CPU 110.

The communication interface 160 is realized by various communications modules, including, for example, wireless LAN communications (such as IEEE 802.11a/b/g/n/ac), ZigBee®, BlueTooth®, and wired LAN such as Ethernet®. The communication interface 160 is provided for data exchange with other devices over wired communications or wireless communications. The CPU 110 receives programs, control instructions, image data, text data, and other such information from other devices, and sends information such as text data and image data to other devices via the communication interface 160. In the present embodiment, the CPU 110 via the communication interface 160 may constantly connect to the constant connection server 200 over the WebSocket protocol, and may communicate with the application server 300 over the HTTP protocol.

### <Hardware Configuration of Constant Connection Server 200>

The following describes an aspect of the hardware configuration of the constant connection server 200. FIG. 12 is a block diagram representing the hardware configuration of the constant connection server 200 according to the present embodiment. The constant connection server 200 can normally use apache, tomcat, mysql, and other such functions available to common server modules.

Referring to FIG. 12, the main constituting elements of the constant connection server 200 include a CPU 210, a memory 220, an input/output unit 230, and a communication interface 260. The hardware configuration of the constant connection server 200 differs from that of the client 100 in that the home appliance control circuit 150 for controlling each part of the home appliances, and the camera 140 are not provided. Other differences are the operation of the CPU 210, and the data stored in the memory 220. Accordingly, the following describes the operation of the CPU 210, and the data stored in the memory 220, and does not describe other hardware configuration.

The CPU 210 controls each part of the constant connection server 200 by running programs stored in the memory 220 or in external storage media. Specifically, the CPU 210 runs the programs stored in the memory 220, and operates as the WS server 210A (see FIGS. 16 to 24).

The memory 220 stores information such as programs run by the CPU 210, data generated after the execution of a program by the CPU 210, input data via the input/output unit 230, service ID, service name, the URL of the connected device of the application server 300, service authentication token generating information, authentication information (one-time key), and connection ID.

### <Hardware Configuration of Application Server 300>

The following describes an aspect of the hardware configuration of the application server 300. FIG. 13 is a block diagram representing the hardware configuration of the application server 300 according to the present embodiment. The application server 300 can normally use apache, tomcat, mysql, and other such functions available to common server modules.

Referring to FIG. 13, the main constituting elements of the application server 300 include a CPU 310, a memory 320, an input/output unit 330, and a communication interface 360. The hardware configuration of the application server 300 differs from that of the client 100 in that the home appliance control circuit 150 for controlling each part of the home appliances is not provided. Other differences are the operation of the CPU 310, and the data stored in the memory 320. Accordingly, the following describes the operation of the CPU 310, and the data stored in the memory 320, and does not describe other hardware configuration.

The CPU 310 controls each part of the application server 300 by running programs stored in the memory 320 or in external storage media. Specifically, the CPU 310 runs the programs stored in the memory 320, and operates as the server APP 310A (see FIGS. 16 to 24) by using the APP data (described later), and as the server API 310B (see FIGS. 16 to 24) by using the API data (described later).

The memory 320 stores programs run by the CPU 310, data generated after the execution of a program by the CPU 310, input data via the input/output unit 330, APP data operating as the application server 300, and API data for communicating with the constant connection server 200 while exchanging data with the server APP. Specifically, the memory 320 stores information such as the URL of the constant connection server, service ID, service authentication token, authentication information (one-time key) generating information, and connection ID.

### <Hardware Configuration of Smartphone 500>

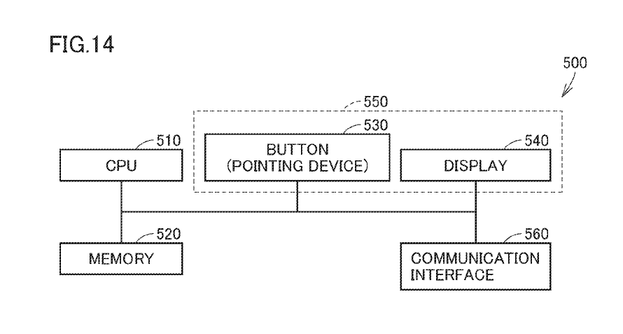

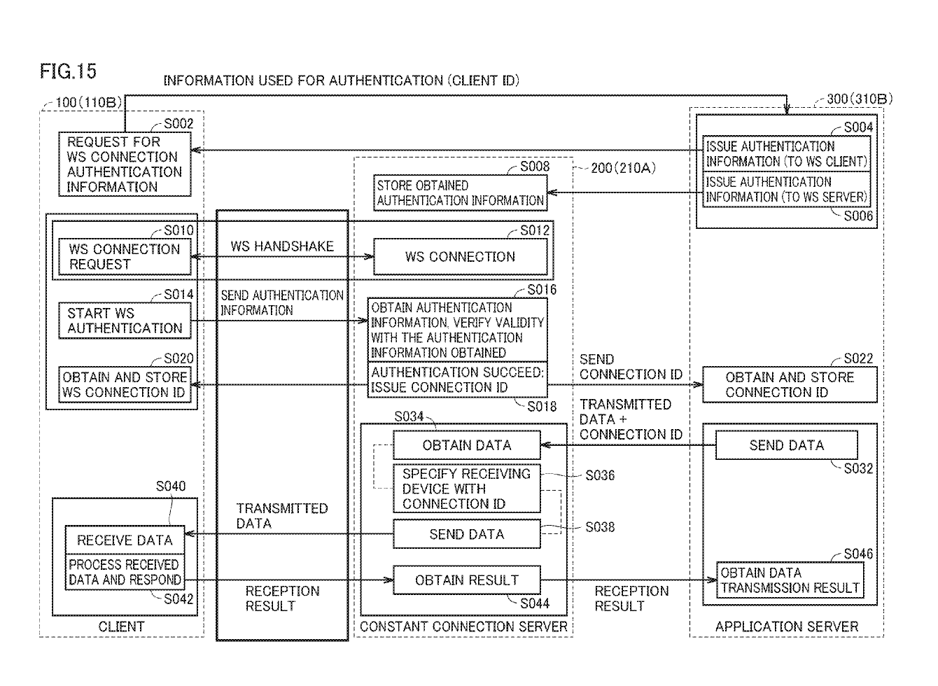

The following describes an aspect of the hardware configuration of the smartphone 500. FIG. 14 is a block diagram representing the hardware configuration of the smartphone 500 according to the present embodiment.

Referring to FIG. 14, the main constituting elements of the smartphone 500 include a CPU 510, a memory 520, a button 530, a display 540, and a communication interface 560, and a camera 570. The hardware configuration of the smartphone 500 differs from that of the client 100 in that the home appliance control circuit 150 for controlling each part of the home appliances is not provided. Other differences are the operation of the CPU 510, and the data stored in the memory 520. Accordingly, the hardware configuration will not be described with regard to these components. Note that it is now more common to use a touch panel in place of the button 530 and the display 540.

### <Data Exchange Between Devices Concerning Constant Connection>

The following is a brief overview of the data exchange between devices concerning the constant connection in the network system 1 according to the present embodiment. FIG. 15 is a sequence diagram representing the procedures of the data exchange between devices concerning the constant connection in the network system 1 according to the present embodiment.

Referring to FIG. 15, the client 100 requests the application server 300 for authentication information over the HTTP protocol (step S002). For authentication, the client 100 sends a client ID to the application server 300. The application server 300 responds to the request by sending authentication information to the client 100 over the HTTP protocol (step S004).

The application server 300 sends authentication information also to the constant connection server 200 (step S006). The constant connection server 200 stores the authentication information sent from the application server 300 (step S008).

The client 100 and the constant connection server 200 establish a WebSocket constant connection state, using the HTTP protocol (step S010, step S012). Specifically, the client 100 sends a handshake request to the constant connection server 200 over the HTTP protocol. The constant connection server 200 returns a handshake response. This establishes a valid WebSocket constant connection between the client 100 and the constant connection server 200.

The client 100 sends the authentication information to the constant connection server 200 (step S014). The constant connection server 200 authenticates the client 100 by using the authentication information from the client 100, and the stored authentication information (step S016). When authentication is successful, the constant connection server 200 issues a connection ID for the identification of the client 100 by the application server 300 (step S018). Specifically, the association between the client 100 and the connection ID in the constant connection is stored as connection status administrative information in the constant connection server 200. The constant connection server 200 sends the connection ID to the application server 300 and the client 100. The client 100 receives and stores the connection ID (step S020). The application server 300 also receives and stores the connection ID (step S022).

As required, the application server 300 sends main data (for example, polling instruction) to the constant connection server 200, together with the connection ID for specifying the receiving client 100 (step S032). The constant connection server 200 receives the main data and the connection ID from the application server 300 (step S034). The constant connection server 200 refers to the connection status administrative information, and specifies the client 100 on the basis of the connection ID (step S036).

The constant connection server 200 sends the main data to the specified client 100 over the WebSocket protocol (step S038). The client 100 receives the main data (step S040). The client 100 sends the reception result to the constant connection server 200 over the WebSocket protocol (step S042). Upon receiving the reception result, the constant connection server 200 sends it to the application server 300 (step S044). The application server 300 receives the reception result (step S046).

The following more specifically describes the procedures in the network system 1 according to the present embodiment. As described above, the client APP 110A is realized by execution of a program by the CPU 110 of the client 100, and controls the operation of the client 100 (FIGS. 10 and 11). The client API 110B is realized by execution of a program by the CPU 110 of the client 100, and communicates with the constant connection server 200 via the communication interface 160 over the HTTP protocol and the WebSocket protocol.

Referring to FIGS. 10 and 13, the server APP 310A is realized by execution of a program by the CPU 310 of the application server 300, and operates as an application service program. The server API 310B is realized by execution of a program by the CPU 310 of the application server 300, and communicates with the constant connection server 200 via the communication interface 360.

Referring to FIGS. 10 and 12, the WS server 210A is realized by execution of a program by the CPU 210 of the constant connection server 200. The WS server 210A communicates with the application server 300 via the communication interface 260 over the HTTP protocol. In the present embodiment, the WS server 210A communicates with the client 100 via the communication interface 260 over the HTTP protocol and the WebSocket protocol.

### <Details of Procedures for Opening Constant Connection>

The following describes details of the procedures for opening a constant connection in the network system 1 according to the present embodiment. FIG. 16 is a sequence diagram representing details of the procedures for opening a constant connection in the network system 1 according to the present embodiment.

Referring to FIG. 16, the client APP 110A transfers to the client API 110B a request for opening a constant connection with the application server 300 (step S102). Here, the client APP 110A transfers a client ID to the client API 110B.

The client API 110B sends the client ID to the application server 300, and requests authentication information via the communication interface 160 over the HTTP protocol (step S104). The client APP 110A or the client API 110B also sends the application server 300 information (argument) necessary for service authentication (step S106).

Upon receiving the client ID and the request, the server API 310B generates authentication information (step S108). The server API 310B notifies the server APP 310A of the request to open a connection (step S110). Upon receiving a connection authorization response from the server APP 310A (step S114), the server API 310B sends authentication information to the constant connection server 200 via the communication interface 360 (step S116). The WS server 210A stores the authentication information in the memory 120 (step S118). The server API 310B sends the authentication information to the client 100 via the communication interface 260 (step S120).

The client API 110B sends a handshake request to the constant connection server 200 via the communication interface 160 over the HTTP protocol (step S122). The WS server 210A returns a handshake response to the client 100 via the communication interface 260 (step S124). This opens a WebSocket constant connection between the client 100 and the constant connection server 200.

The client API 110B sends the authentication information to the constant connection server 200 via the communication interface 160 over the WebSocket protocol (step S126). The WS server 210A authenticates the client 100 by using the authentication information previously received from the application server 300, and the current authentication information received from the client 100 (step S128).

When authentication is successful, the WS server 210A issues a connection ID (step S130). The WS server 210A sends the connection ID of the client 100 (connection establishment status) to the application server 300 via the communication interface 260 (step S132). The server API 310B stores the connection ID in the memory 320 (step S134). The server API 310B notifies the server APP 310A of the connection establishment status (step S136). The server API 310B then deletes the authentication information (step S138).

The WS server 210A responds to the authentication request by sending the connection ID to the client 100 via the communication interface 260 over the WebSocket protocol (step S144). The client API 110B stores the connection ID.

The client API 110B requests a connection check via the communication interface 160 over the WebSocket protocol (step S146). Upon receiving the request, the WS server 210A responds to the connection check via the communication interface 260 over the WebSocket protocol (step S148). In response, the client API 110B notifies the client APP 100A that the constant connection is open (step S150).

<Details of Procedures for Closing Constant Connection from Client>

The following describes details of the procedures for closing a constant connection from client in the network system 1 according to the present embodiment. FIG. 17 is a sequence diagram representing details of the procedures for closing a constant connection from client in the network system 1 according to the present embodiment.

Referring to FIG. 17, the client APP 110A transfers to the client API 110B a request for closing the constant connection with the application server 300 (step S202). Here, the client 100 also transfers a connection ID to the client API 110B.

The client API 110B requests the constant connection server 200 to close the constant connection via the communication interface 160 over the WebSocket protocol (step S204). The WS server 210A acknowledges the closure of the constant connection via the communication interface 260 over the WebSocket protocol (step S206).

The client API 110B terminates the constant connection with the constant connection server 200, and the TCP communication with the constant connection server 200 (step S208). The client API 110B notifies the client APP 100A of the termination of the constant connection (step S210).

The WS server 210A terminates the constant connection with the client 100, and the TCP communication with the client 100 (step S212). The WS server 210A notifies the application server 300 via the communication interface 260 that the constant connection is closed (step S214).

In response to the notification, the server API 310B notifies the server APP 310A that the constant connection with the client 100 has been terminated (step S218). Specifically, the server API 310B transfers to the server APP 310A the associated connection ID of the client 100 for which the constant connection has been terminated.

<Details of Procedures for Closing Constant Connection from Application Server>

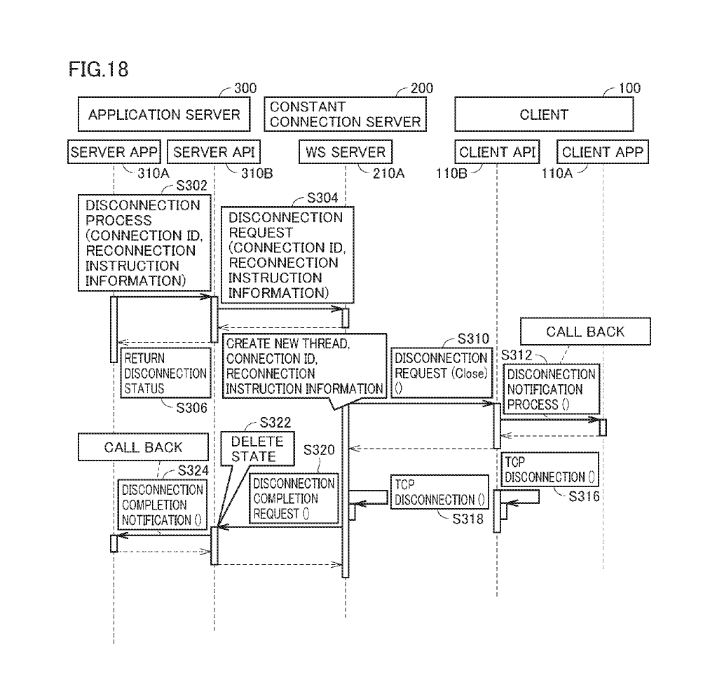

The following describes details of the procedures for closing a constant connection from application server 300 in the network system. 1 according to the present embodiment. The application server 300 may close a constant connection with client 100 when updating programs or fixing troubles during maintenance. FIG. 18 is a sequence diagram representing details of the procedures for closing a constant connection from application server 300 in the network system 1 according to the present embodiment.

Referring to FIG. 18, the server APP 310A transfers to the server API 310B a request for closing the constant connection with the client 100 (step S302). Here, the server APP 310A also transfers the connection ID of the client 100 of interest to the server API 310B.

The server API 310B requests the constant connection server 200 to close the constant connection with the client 100 via the communication interface 360 (step S304). The WS server 210A acknowledges the closure of the constant connection via the communication interface 260. The server API 310B notifies the server APP 310A of the termination of the constant connection with the client 100 (step S306).

The WS server 210A requests the client 100 to close the constant connection via the communication interface 260 over the WebSocket protocol (step S310). In response to the request, the client API 110B notifies the client APP 100A of the intension to close the constant connection (step S312). The client API 110B terminates the constant connection with the constant connection server 200, and the TCP communication with the constant connection server 200 (step S316).

The WS server 210A terminates the constant connection with the client 100, and the TCP communication with the client 100 (step S318). The WS server 210A notifies the server API 310B via the communication interface 260 that the constant connection with the client 100 is closed (step S320).

In response to the notification, the server API 310B deletes the connection ID of the client 100 from the connection status administrative information stored in the memory 320 (step S322). The server API 310B notifies the server APP 310A of the completion of the disconnection process (step S324).

<Details of Procedures for Checking Connection from Client>

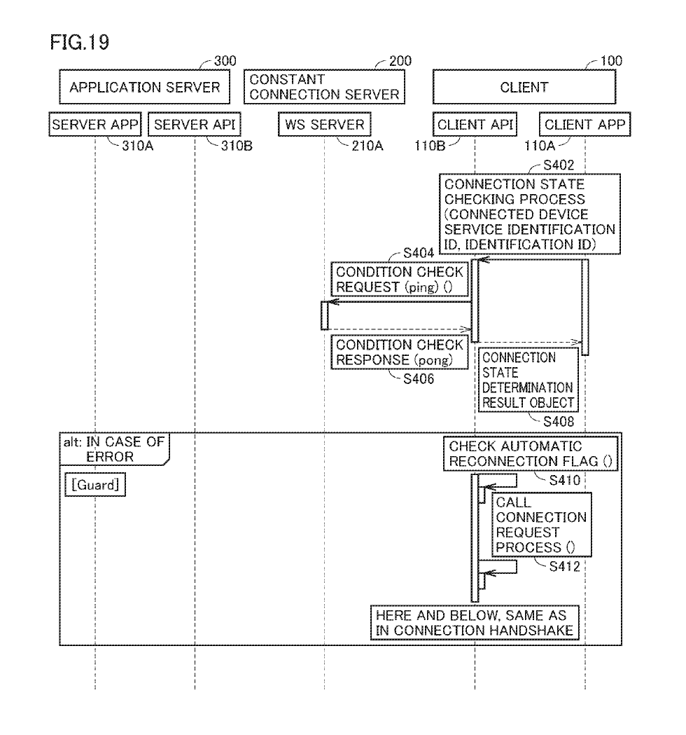

The following describes details of the procedures for checking a connection from client 100 in the network system 1 according to the present embodiment. The client 100 may close the constant connection with the application server 300 when there is no data reception over the constant connection for a certain time period, and when there are user instructions for disabling the constant connection function. FIG. 19 is a sequence diagram representing details of the procedures for checking a connection from client 100 in the network system 1 according to the present embodiment.

Referring to FIG. 19, the client APP 100A requests the client API 110B to check a connection with the constant connection server 200 (step S402). The client API 110B sends a connection check request (ping) to the constant connection server 200 via the communication interface 160 over the WebSocket protocol (step S404).

Upon receiving the connection check request (ping), the WS server 210A sends a connection check response (pong) to the client 100 via the communication interface 260 (step S406). The client API 110B notifies the client APP 100A of the result of connection status determination (step S408).

When the constant connection server 200 does not return a connection check response (pong), the client API 110B checks the automatic reconnection flag, and calls up a process for requesting a constant connection (step S412). The network system 1 then performs the same process used to open a constant connection (see FIGS. 15 and 16).

<Details of Procedures for Checking Connection from Application Server>

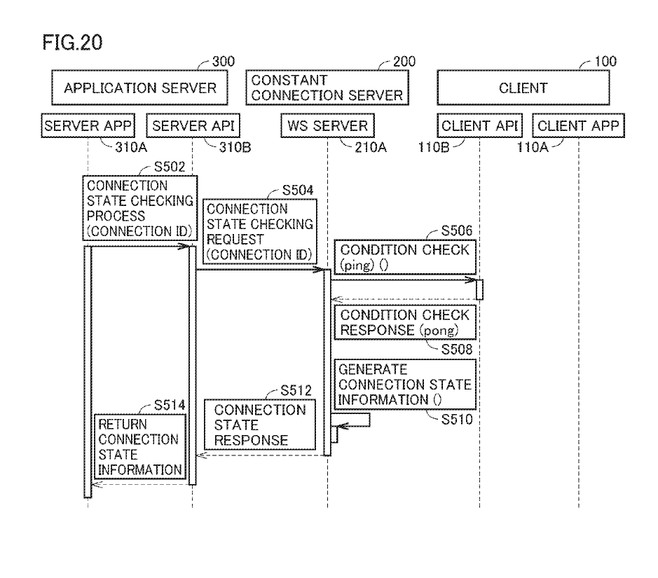

The following describes details of the procedures for checking a connection from application server 300 in the network system 1 according to the present embodiment. FIG. 20 is a sequence diagram representing details of the procedures for checking a connection from application server 300 in the network system 1 according to the present embodiment.

Referring to FIG. 20, the server APP 310A requests the server API 310B to check a connection with the constant connection server 200 and the client 100 (step S502). The server API 310B requests the constant connection server 200 to check a connection with the client 100 via the communication interface 360 (step S504).

The WS server 210A sends a connection check request (ping) to the client 100 via the communication interface 260 over the WebSocket protocol (step S506). Upon receiving the connection check request (ping), the client API 110B sends a connection check response (pong) to the constant connection server 200 via the communication interface 260 over the WebSocket protocol (step S508).

Upon receiving the connection check response (pong), the WS server 210A creates connection status information (step S510). The WS server 210A sends the connection status information to the application server 300 via the communication interface 260 (step S512). The server API 310B transfers the connection status information to the server APP 310A (step S514).

<Details of Procedures for Normal Data Pushing Operation from Application Server>

The following describes details of the procedures for pushing data from application server 300 in the network system 1 according to the present embodiment. Specifically, the data pushing procedures in the network system 1 according to the present embodiment will be separately described for normal (small volume) data pushing operation and large volume data pushing operation from application server 300.

Examples of the small volume data sent from the application server 300 include text files such as commands, and small image/audio/video files (small content for playback). Examples of the large volume data sent from the application server 300 include large image/audio/video files.

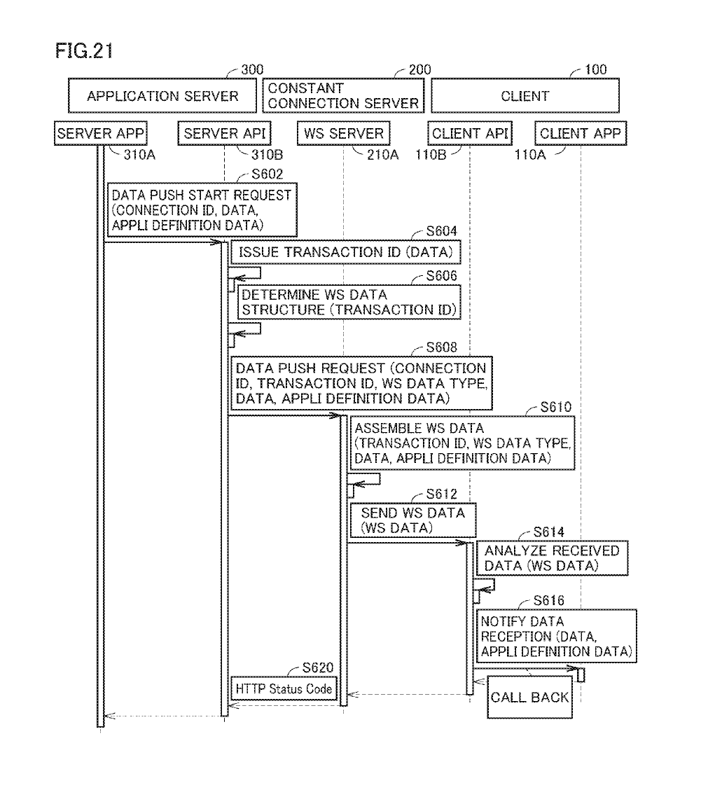

The data pushing procedures from the application server 300 in the network system 1 according to the present embodiment are described below in detail. FIG. 21 is a sequence diagram representing details of the normal data pushing procedures from the application server 300 in the network system 1 according to the present embodiment.

Referring to FIG. 21, the server APP 310A requests the server API 310B to push data (step S602). Specifically, the server APP 310A transfers to the server API 310B a connection ID for specifying the client 100, main data, and data for specifying an application. The server API 310B issues a transaction ID (step S604).

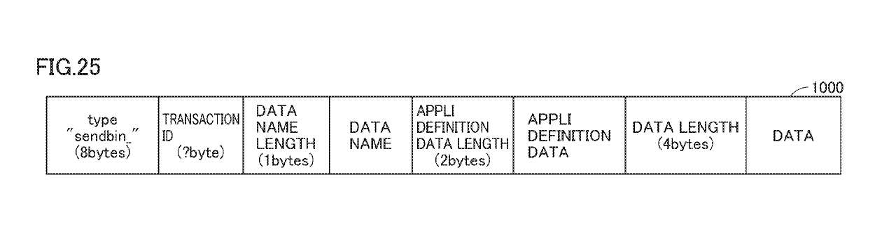

The server API 310B determines the WS data structure (step S606). FIG. 25 is a schematic diagram representing the structure of WS data according to the present embodiment. As shown in FIG. 25, WS data 1000 contains, for example, type “sendbin_” (8 bytes), transaction ID, data length, data name, application definition data length, application definition data, data length, and main data. In the present embodiment, the server API 310B determines whether the main data volume is larger than a predetermined value. Alternatively, the server API 310B determines whether the total data volume to be sent to the client 100 is larger than a predetermined value. The following describes the case where the data volume is no larger than the predetermined value.

The server API 310B requests the constant connection server 200 to push data (step S608). Specifically, the server API 310B sends the connection ID, the transaction ID, the WS data type, the main data, and the data for specifying an application to the constant connection server 200 via the communication interface 360.

The WS server 210A receives the data from the application server 300, and reconstructs the data to accommodate the WebSocket protocol (step S610). The WS server 210A sends the connection ID, the transaction ID, the WS data type, the main data, and the data for specifying an application to the client 100 via the communication interface 260 over the WebSocket protocol (step S612).

The client API 110B receives the data from the constant connection server 200 via the communication interface 160 over the WebSocket protocol. The client API 110B analyzes the received WS data (step S614). The client API 110B transfers the received data to the client APP 100A (step S616).

The client API 110B sends the data with the transaction ID via the communication interface 160 over the WebSocket protocol to notify the constant connection server 200 that the main data has been received by the client 100. The WS server 210A sends the data with the transaction ID via the communication interface 260 to notify the application server 300 that the client 100 has received the main data (step S620).

<Details of Procedures for Large Volume Data Pushing Operation from Application Server>

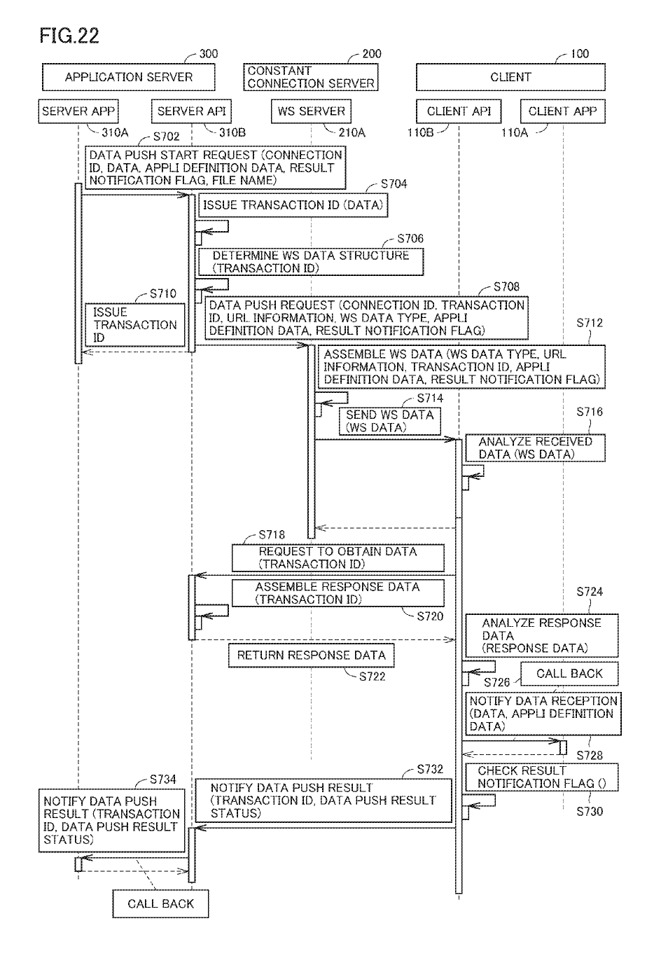

The following describes the procedures for pushing large volume data from application server 300 in the network system 1 according to the present embodiment. FIG. 22 is a sequence diagram representing details of the procedures for pushing large volume data from application server 300 in the network system 1 according to the present embodiment.

Referring to FIG. 22, the server APP 310A requests the server API 310B to push data (step S702). Specifically, the server APP 310A transfers to the server API 310B a connection ID for specifying the client 100, main data, and data for specifying an application. The server API 310B issues a transaction ID (step S704).

The server API 310B determines the WS data structure (step S706). In the present embodiment, the server API 310B determines whether the main data volume is larger than a predetermined value. Alternatively, the server API 310B determines whether the total data volume to be sent to the client 100 is larger than a predetermined value. The following describes the case where the data volume is larger than the predetermined value.

The server API 310B requests the constant connection server 200 to push data (step S708). Specifically, the server API 310B sends the connection ID, the transaction ID, the URL information, the WS data type, the data for specifying an application, and the result notification flag to the constant connection server 200 via the communication interface 360. Here, the server API 310B transfers the transaction ID also to the server APP 310A (step S710).

The WS server 210A receives the data from the application server 300, and reconstructs the data to accommodate the WebSocket protocol (step S712). The WS server 210A sends the connection ID, the transaction ID, the URL information, the WS data type, the data for specifying an application, and the result notification flag to the client 100 via the communication interface 260 over the WebSocket protocol (step S714).

The client API 110B receives the data from the constant connection server 200 via the communication interface 160 over the WebSocket protocol. The client API 110B analyzes the received data (step S716).

By using the received URL information and transaction ID, the client API 110B requests the application server 300 for data via the communication interface 160 over the HTTP protocol (step S718). In response to the request, the server API 310B assembles the data to be the sent to the client 100 (step S720). The server API 310B sends main data to the client 100 via the communication interface 360 over the HTTP protocol (step S722). Specifically, the client API 110B via the communication interface 260 downloads data from the application server 300 at the location indicated by the URL, using the HTTP protocol.

The client API 110B analyzes the received data (step S724). The client API 110B transfers the received data to the client APP 100A (step S726). The client API 110B checks the result notification flag (step S728).

The client API 110B notifies the application server 300 via the communication interface 160 that the data has been received by the client, using the HTTP protocol (step S732). Specifically, the client API 110B sends the transaction ID and a data push result status to the application server 300. The server API 310B transfers the transaction ID and the data push result status to the server APP 310A (step S734).

The foregoing described the case where the application server 300 determines the data size in the manner represented in FIGS. 21 and 22. However, the data size may be determined by the constant connection server 200, as in FIGS. 6 and 7.

Further, instead of the client 100 downloading large volume data from the application server 300 in the manner described with reference to FIG. 22, the client 100 may download the data from the constant connection server 200 or some other Web server, as in FIG. 7. That is, the system may be configured so that the application server 300 sends data to the constant connection server 200 or some other Web server, and the client 100 downloads the data from the constant connection server 200 or some other Web server.

<Details of Procedures for Normal Data Pushing Operation from Client>

The following describes details of the procedures for pushing data from client 100 in the network system 1 according to the present embodiment. Specifically, the data pushing procedures in the network system 1 according to the present embodiment will be separately described for normal (small volume) data pushing operation and large volume data pushing operation from client 100.

Examples of the small volume data sent from the client 100 include text files such as date log, and small image/audio/video files (such as camera image, and audio for voice recognition). Examples of the large volume data sent from the client 100 include text files such as large logs retained for longer than several days, and large image/audio/video files.

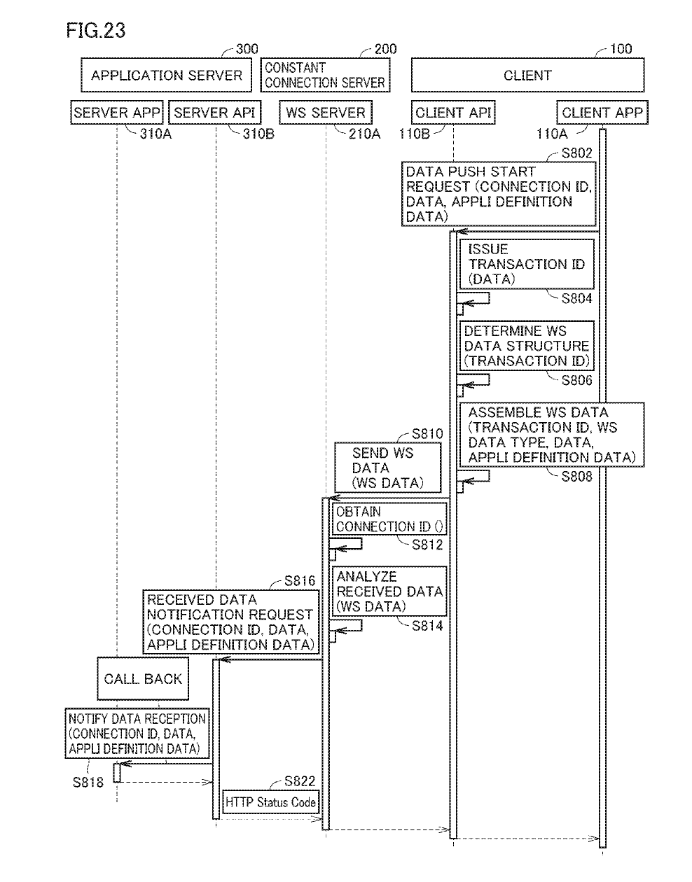

The normal data pushing procedures from the client 100 in the network system 1 according to the present embodiment are described below in detail. FIG. 23 is a sequence diagram representing details of the normal data pushing procedures from the client 100 in the network system. 1 according to the present embodiment.

Referring to FIG. 23, the client APP 110A requests the client API 110B to push data (step S802). Specifically, the client APP 110A transfers a connection ID for specifying itself, main data, and data for specifying an application to the client API 110B. The server API 310B issues a transaction ID (step S804).

The client API 110B determines the WS data structure (step S806). In the present embodiment, the client API 110B determines whether the main data volume is larger than a predetermined value. Alternatively, the client API 110B determines whether the total data volume to be sent to the constant connection server 200 is larger than a predetermined value. The following describes the case where the data volume is no larger than the predetermined value.

The client API 110B reconstructs the WS data containing the connection ID, the transaction ID, the WS data type, the main data, and the data for specifying an application to accommodate the WebSocket protocol (step S808). The client API 110B sends the assembled WS data to the constant connection server 200 via the communication interface 160 over the WebSocket protocol (step S810).

The WS server 210A obtains the connection ID from the WS data (step S812). The WS server 210A analyzes the received WS data (step S814). The WS server 210A sends the data sent from the client 100, via the communication interface 260 (step S816). More specifically, the WS server 210A sends the connection ID of the client 100, the main data, and the data for specifying an application to the application server 300 via the communication interface 160 over the HTTP protocol.

The server API 310B transfers the received data to the server APP 310A (step S818). The server API 310B sends the data containing the transaction ID via the communication interface 360 to notify the constant connection server 200 that the application server 300 has received the main data (step S822). The WS server 210A sends the data containing the transaction ID via the communication interface 360 to notify that the application server 300 has received the main data, using the WebSocket protocol.

<Details of Procedures for Large Volume Data Pushing Operation from Client>

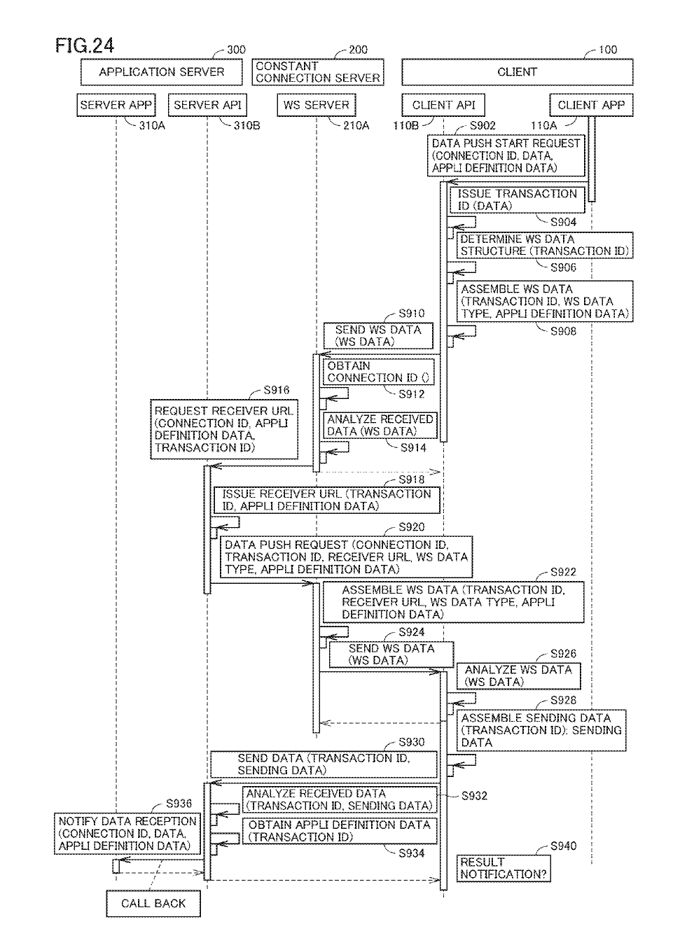

The following describes the procedures for pushing large volume data from client 100 in the network system 1 according to the present embodiment. FIG. 24 is a sequence diagram representing details of the procedures for pushing large volume data from client 100 in the network system 1 according to the present embodiment.

Referring to FIG. 24, the client APP 110A request the client API 110B to push data (step S902). Specifically, the client APP 110A transfers a connection ID for specifying the client 100, main data, and data for specifying an application to the client API 110B. The client API 110B issues a transaction ID (step S904).

The client API 110B determines the WS data structure (step S906). In the present embodiment, the client API 110B determines whether the main data volume is larger than a predetermined value. Alternatively, the client API 110B determines whether the total data volume to be sent to the constant connection server 200 is larger than a predetermined value. The following describes the case where the data volume is larger than the predetermined value.

The client API 110B reconstructs the WS data containing the connection ID, the transaction ID, the WS data type, the data for specifying an application, and the data volume to accommodate the WebSocket protocol (step S908). The client API 110B sends the assembled WS data to the constant connection server 200 via the communication interface 160 over the WebSocket protocol (step S910).

The WS server 210A obtains the connection ID from the received WS data (step S912). The WS server 210A analyzes the received WS data (step S914). The WS server 210A via the communication interface 260 requests the application server 300 for the receiving URL of the main data (step S916). Specifically, the WS server 210A sends the connection ID, the application definition data, and the transaction ID to the application server 300 via the communication interface 260.

In response to the request from the constant connection server 200, the server API 310B issues a URL for uploading (step S918). The server API 310B via the communication interface 360 requests the constant connection server 200 to push data to the client 100 (step S920). Specifically, the server API 310B sends the connection ID, the transaction ID, the receiving URL, the WS data type, and the information for specifying an application to the constant connection server 200 via the communication interface 360 over the HTTP protocol.

The WS server 210A assembles data to accommodate the WebSocket protocol by using the information received from the application server 300 (step S922). The WS server 210A sends the WS data to the client 100 via the communication interface 260 over the WebSocket protocol (step S924).

The client API 110B analyzes the WS data (step S926). The client API 110B assembles sending (uploading) data by using the main data (step S928). By using the URL information, the client API 110B uploads the main data and the transaction ID to the receiving URL of the application server 300 via the communication interface 160 over the HTTP protocol (step S930).

The server API 310B analyzes the received data (step S932). The server API 310B obtains the transaction ID and the main data (step S934). The server API 310B transfers the connection ID, the main data, and the information for specifying an application to the server APP 310A (step S936).

The server API 310B sends the data containing the transaction ID via the communication interface 360 to notify the constant connection server 200 that the application server 300 has received the main data. The WS server 210A sends the data containing the transaction ID via the communication interface 260 to notify that the application server 300 has received the main data, using the WebSocket protocol (step S940).

The foregoing described the case where the client 100 uploads large volume data to the application server 300 in the manner described with reference to FIG. 24. However, the client 100 may upload the data to the constant connection server 200 or some other server, as in FIG. 9. The constant connection server 200 or some other server may then send the data to the application server 300.

The foregoing described the various procedures of the network system 1. The network system 1 according to the present embodiment enables data from the application server 300 to be pushed to a selected client 100 by using a connection ID. The burden on the network system can be reduced because the client 100 and the application server 300 mutually push data via the constant connection server 200. Further, because the protocols are switched according to the transmitted data volume, communications using the WebSocket protocol are less likely to be occupied by some of the data sent and received, and it is less likely that sending and receiving of other Websocket data is obstructed.

### Second Embodiment

The following describes Second Embodiment. In the network system 1 according to First Embodiment, at least one of the client 100 and the constant connection server 200 uses the common HTTP protocol and the WebSocket protocol for different purposes. More specifically, at least one of the client 100 and the constant connection server 200 sends and receives data over the HTTP protocol when the transmitted data volume is larger than the predetermined value, and sends and receives data over the WebSocket protocol when the transmitted data volume is no larger than the predetermined value.

In the present embodiment, however, the protocol is appropriately determined on the basis of the communication speed, not the data volume. The data requiring high communication speeds in the transmitted data from the application server 300 are, for example, command data for which a command needs to be immediately issued (such as in turning on and off an air conditioner), and image/audio/video files that need immediate playback (urgent messages such as an earthquake early warning). On the other hand, the data transmitted by the client 100 require high communication speeds when, for example, image and sound data need to be immediately played at the terminal (smartphone) side.

The following describes the present embodiment in detail. First, the server API 310B in the present embodiment determines in step S606 of FIG. 21 and step S706 of FIG. 22 whether the current communication speed over the WebSocket protocol is below a predetermined value. Alternatively, the server API 310B determines whether the communication speed of the data of interest to be sent over the WebSocket protocol is below a predetermined value.

Specifically, the server API 310B may send a speed check signal (ping) to the client 100 via the communication interface 360, and count the time to receive a response signal (pong) and calculate the communication speed. Alternatively, the server API 310B may cause the WS server 210A to perform the same calculation to find the communication speed.

The sequence beginning with step S608 describes the case where the communication speed is at or greater than the predetermined value. The sequence beginning with step S708 describes the case where the communication speed is below the predetermined value.

Similarly, the client API 110B in the present embodiment determines in step S806 of FIG. 23 and step S906 of FIG. 24 whether the current communication speed over the WebSocket protocol is below a predetermined value. Alternatively, the client API 110B determines whether the communication speed of the data of interest to be sent over the WebSocket protocol is below a predetermined value.

The sequence beginning with step S808 describes the case where the communication speed is at or greater than the predetermined value. The sequence beginning with step S908 describes the case where the communication speed is below the predetermined value.

The embodiment has been described through the case where the application server 300 makes the decision. However, the decision may be made by the constant connection server 200, as with the case of FIGS. 6 and 7.

### Third Embodiment

The following Third Embodiment describes switching of protocols. In the present embodiment, the protocol is appropriately determined on the basis of the transmission time, as follows.

First, the server API 310B in the present embodiment determines in step S606 of FIG. 21 and step S706 of FIG. 22 whether the transmission time of the data of interest to be sent over the WebSocket protocol will be longer than a predetermined value. The sequence beginning with step S608 describes the case where the transmission time is no longer than the predetermined value. The sequence beginning with step S708 describes the case where the transmission time is longer than the predetermined value.

Similarly, the client API 110B in the present embodiment determines in step S806 of FIG. 23 and step S906 of FIG. 24 whether the transmission time of the data of interest to be sent over the WebSocket protocol will be longer than a predetermined value. The sequence beginning with step S808 describes the case where the transmission time is no longer than the predetermined value. The sequence beginning with step S908 describes the case where the transmission time is longer than the predetermined value.

The embodiment has been described through the case where the application server 300 makes the decision. However, the decision may be made by the constant connection server 200, as with the case of FIGS. 6 and 7.

### Fourth Embodiment

The following Fourth Embodiment also describes switching of protocols. In the present embodiment, the protocol is appropriately determined on the basis of the frequency of data transmission and reception over the WebSocket protocol. The transmitted data from the application server 300 have high transmission and reception frequency in, for example, condition check data. The transmitted data from the client 100 has high transmission and reception frequency in, for example, condition check data and log data.

The following describes the present embodiment in detail. First, the server API 310B in the present embodiment determines in step S606 of FIG. 21 and step S706 of FIG. 22 whether the frequency of the data sent and received over the WebSocket protocol is greater than a predetermined value. For example, the server API 310B counts the number of times data is sent and received in one minute over the WebSocket protocol between the constant connection server 200 and the client 100. Alternatively, the server API 310B obtains from the WS server 210A the number of times data is sent and received in one minute over the WebSocket protocol between the constant connection server 200 and the client 100. The sequence beginning with step S608 describes the case where the count is no greater than the predetermined value. The sequence beginning with step S708 describes the case where the count is greater than the predetermined value.

Similarly, the client API 110B in the present embodiment determines in step S806 of FIG. 23 and step S906 of FIG. 24 whether the frequency of the data sent and received over the WebSocket protocol is greater than a predetermined value. For example, the client 100 counts the number of times data is sent and received in one minute over the WebSocket protocol between the constant connection server 200 and the client 100. The client 100 determines whether the count is greater than the predetermined value. The sequence beginning with step S808 describes the case where the count is no greater than the predetermined value. The sequence beginning with step S908 describes the case where the count is greater than the predetermined value.

The embodiment has been described through the case where the application server 300 makes the decision. However, the decision may be made by the constant connection server 200, as with the case of FIGS. 6 and 7.

### Fifth Embodiment

Fifth Embodiment is described below. In the network systems 1 according to the foregoing First to Fourth Embodiments, the constant connection server 200 serves as the WS server 210A that controls the sending and receiving of data with the client 100, and the application servers 300 function as the server APP 310A (program), and the server API 310B that generates authentication information.

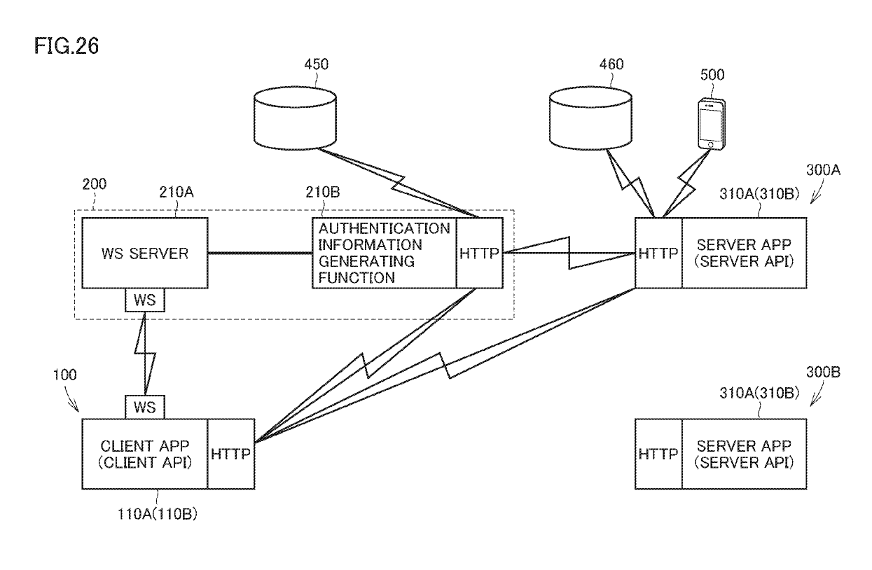

In the present embodiment, however, the constant connection server 200 has an authentication information generating function 210B. FIG. 26 is a schematic diagram representing the communication configuration of the network system 1 according to Fifth Embodiment.

### Sixth Embodiment

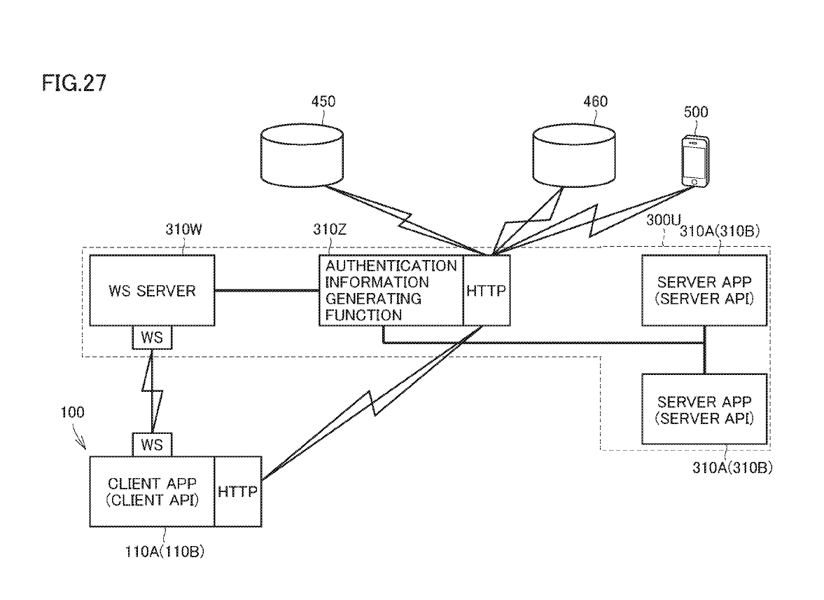

Sixth Embodiment is described below. In the present embodiment, the application server 300U has a WS server 310W function, an authentication information generating function 310Z, and two server functions (two servers APP 310A). FIG. 27 is a schematic diagram representing the communication configuration of the network system 1 according to Seventh Embodiment. In the network system 1 according to the present embodiment, the client 100 has the same configuration as that described in First Embodiment, and will not be described further.

Referring to FIG. 27, the application server 300U has a WS server 310W (program) function for controlling WebSocket protocol communications, an authentication information generating function 310Z, a server APP 310A function (first service program), and an APP 310A function (second service program). The two servers APP 310A can each communicate with other devices such as database and a smartphone 500 over the HTTP protocol. The servers APP 310A can also push information to the client 100 over the WebSocket protocol using the WS server 310W.

### Seventh Embodiment

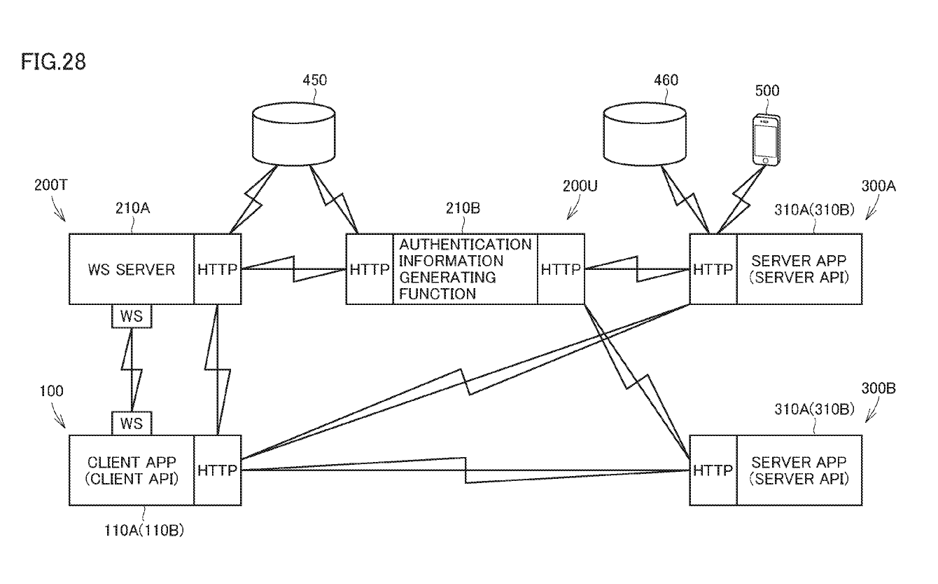

Seventh Embodiment is described below. The present embodiment differs from Fifth and Sixth Embodiments in that the WS server function, the authentication information generating function, and the two server APP functions are installed in different computers. FIG. 28 is a schematic diagram representing the communication configuration of the network system 1 according to Eighth Embodiment.

Referring to FIG. 28, the client 100 may communicate with a constant connection server 200T, an authentication information generating server 200U, and application servers 300A and 300B over the HTTP protocol, and may constantly connect to the constant connection server 200T over the WebSocket protocol. More specifically, the client 100 has client APP 110A and client API 110B. The client APP 110A controls each part of the client 100. The client API 110B communicates via the communication interface 160 over the HTTP protocol, or communicates over the WebSocket protocol on the HTTP protocol.

The constant connection server 200T has a WS server 210A (program) for controlling the constant connection communications with the client 100 over the WebSocket protocol. The constant connection server 200T may access other database 450 over the HTTP protocol.

The authentication information generating server 200U controls communications with the plurality of application servers 300 over the HTTP protocol. In the present embodiment, the constant connection server 200T may send data to the application servers 300A and 300B at any timing via the authentication information generating server 200U over the HTTP protocol.

The network systems 1 according to Second to Seventh Embodiments also include a plurality of application servers, 300A and 300B. The application servers 300A and 300B each include a server APP 310A (program) for providing services to devices such as the client 100 and the smartphone 500, and a server API 310B for communicating with the constant connection server 200 over the HTTP protocol.

For example, the network system 1 includes an application server 300A for controlling a vacuum cleaner 100A, and an application server 300B for controlling an air conditioner 100B. The application servers 300A and 300B may each communicate with devices such as the constant connection server 200, other database, and the smartphone 500 over the HTTP protocol. In the present embodiment, the application servers 300A and 300B may send data to the constant connection server 200 at any timing over the HTTP protocol.

### Eighth Embodiment

In the foregoing First to Fourth Embodiments, the decision whether to send data over the WebSocket protocol or the HTTP protocol is based on one criterion. However, the client 100, the constant connection server 200, and the application server 300 may make the decision according to two or more criteria. In the following, the client 100, the constant connection server 200, and the application server 300 will also be collectively called computers for the sake explanation.

For example, the computer may decide according to the criteria of First and Second Embodiments. The computer may upload or download data over the HTTP protocol when the conditions of First and Second Embodiments are both satisfied. Alternatively, the computer may upload or download data over the HTTP protocol when at least one of the conditions of First and Second Embodiments is satisfied.

Similarly, the computer may decide according to the criteria of First and Third Embodiments, the criteria of First and Fourth Embodiments, the criteria of Second and Third Embodiments, the criteria of Second and Fourth Embodiments, or the criteria of Third and Fifth Embodiments. Further, the decision by the computer may be based on three or more criteria. The computer may upload or download data over the HTTP protocol when all or some of the conditions are satisfied.

### Ninth Embodiment

### Overall Configuration of Network System

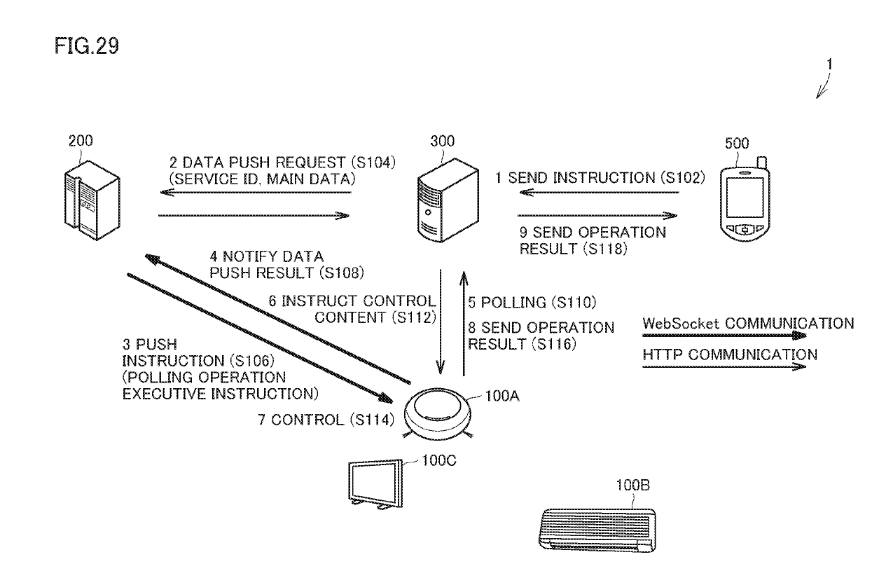

The overall configuration of the network system 1 according to Ninth Embodiment is described below. FIG. 29 is a schematic diagram briefly representing the overall configuration and operation of the network system 1 according to the present embodiment.

Referring to FIG. 29, the network system 1 includes a plurality of clients 100A, 100B, and 100C provided in places such as homes and offices, a constant connection server 200 capable of making constant connections with the clients 100A, 100B, and 100C, and an application server 300 for providing various services concerning the clients 100A, 100B, and 100C. Examples of the clients include home appliances such as a vacuum cleaner 100A, an air conditioner 100B, a television 100C, washing machines, refrigerators, rice cookers, air purifiers, floor heating systems, IH (Induction Heating) cooking heaters, microwave ovens, and illuminations. The clients may be any communications devices, including, for example, personal computers, audio-video equipment other than television, and an intercom system. The constant connection server 200 and the application server 300 may include servers that reside in the same home, office, building, company, or school where the clients are provided.

The home appliances and each server may be connected to each other via lines such as optical fibers, with an optical network unit, a wireless LAN communication access point, and a router optionally connected in between. The means by which the home appliances are connected to the network is not limited, and may be, for example, wireless LAN communications such as IEEE 802.11a/b/g/n/ac, and wired LAN.

In the present embodiment, the vacuum cleaner 100A and the television 100C can make constant connections with the constant connection server 200 over the WebSocket protocol. The vacuum cleaner 100A, by using the HTTP protocol, also can send and receive data to and from the application server 300 providing various services. Similarly, by using the HTTP protocol, the television 100C can send and receive data to and from the application server 300 providing various services.

The air conditioner 100B does not accommodate the WebSocket protocol, and is unable to make a constant connection with the constant connection server 200. Alternatively, the air conditioner 100B is connected to the Internet via a proxy server (not illustrated), and cannot make a constant connection with the constant connection server 200. The air conditioner 100B, however, can directly send and receive data over the HTTP protocol to and from the application server 300 providing various services, as typically performed in the art.

In the present embodiment, the constant connection server 200 and the application server 300 are different computers. In other words, the constant connection server 200 runs a service program for making a constant connection with the client. The application server 300 runs a service program for controlling the client with the information sent to the client, and a service program for obtaining information from the client and using the information in other electronic devices.

However, the constant connection server and the application server may be the same computer. For example, a single computer, specifically a server in the form of a device may contain a communications service program for constantly connecting to the clients, and an application service program for controlling the clients. A single application server may contain a plurality of application service programs.

The configuration according to the present embodiment is applicable not only to the HTTP/WebSocket protocol, but to the HTTPS/WSS protocol that can encrypt communication channels with SSL. That is, the network system 1 according to the present embodiment is also applicable to a system using the HTTPS/WSS protocol.

### <Brief Overview of Network System Operation>

The following is a brief overview of the operation of the network system 1 according to the present embodiment. The clients (the vacuum cleaner 100A, the air conditioner 100B, and the television 100C) each poll the application server 300 over the HTTP protocol on a regular basis. It should be noted, however, that the vacuum cleaner 100A and the television 100C, capable of making a constant connection with the constant connection server 200, do not necessarily require regular polling.

The following describes the case where the user of a communications device such as a smartphone 500 and a personal computer uses the services provided by the application server 300 from outside. The smartphone 500 sends the application server 300 an instruction for the service intended for the vacuum cleaner 100A (hereinafter, also referred to as “service data”) (step S102).

The application server 300 via the constant connection server 200 sends a polling operation executive instruction (hereinafter, also referred to simply as “polling instruction”) for instructing the vacuum cleaner 100A to poll (step S104, step S106). Specifically, the application server 300 sends the constant connection server 200 a connection ID for specifying a combination of the vacuum cleaner 100A and the service for vacuum cleaner, together with the polling instruction (step S104).

The constant connection server 200, by using the connection ID, sends the polling instruction to the vacuum cleaner 100A over the WebSocket protocol (step S106).

By using the WebSocket protocol, the vacuum cleaner 100A notifies the constant connection server 200 of the receipt of the polling instruction (step S108). The vacuum cleaner 100A then polls the application server 300 over the HTTP protocol (step S110).

In response to the polling, the application server 300 sends the service data to the vacuum cleaner over the HTTP protocol (step S112).

The vacuum cleaner 10 OA operates according to the service data (step S114). The vacuum cleaner 100A notifies the application server 300 of the receipt of the service data, and/or the completion of the operation over the HTTP protocol (step S116).

The application server 300 may send the data from the client 100 to communications devices such as the smartphone 500 (step S118). The smartphone 500 outputs the completion of the operation corresponding to the input instruction, either on a display screen or through a speaker.

In this manner, in the present embodiment, the application server 300 can send service data to the vacuum cleaner 100A without having the need to wait for the regularly incoming polling from the vacuum cleaner 100A. The same is the case for the television 100C in a constant connection with the constant connection server 200, and the application server 300 can send service data to the television 100C without having the need to wait for the regularly incoming polling from the television 100C.

For the air conditioner 100B and other home appliances (including other vacuum cleaners) that do not accommodate constant connection, the application server 300 can send service data to the air conditioner 100B or other home appliances in response to the polling from these devices, as typically performed in the art.

Specifically, in the present embodiment, sending and receiving of data between a constant-connection incompatible client and server is possible as typically performed in the art, despite that the system uses a constant connection. The following specifically describes the configuration by which such a function is realized in the network system 1.

### <Hardware Configuration of Client 100>

The following describes an aspect of the hardware configuration of the client 100. Referring to FIG. 11, the main constituting elements of the client 100 include a CPU 110, a memory 120, an input/output unit 130, a camera 140, a home appliance control circuit 150, and a communication interface 160.

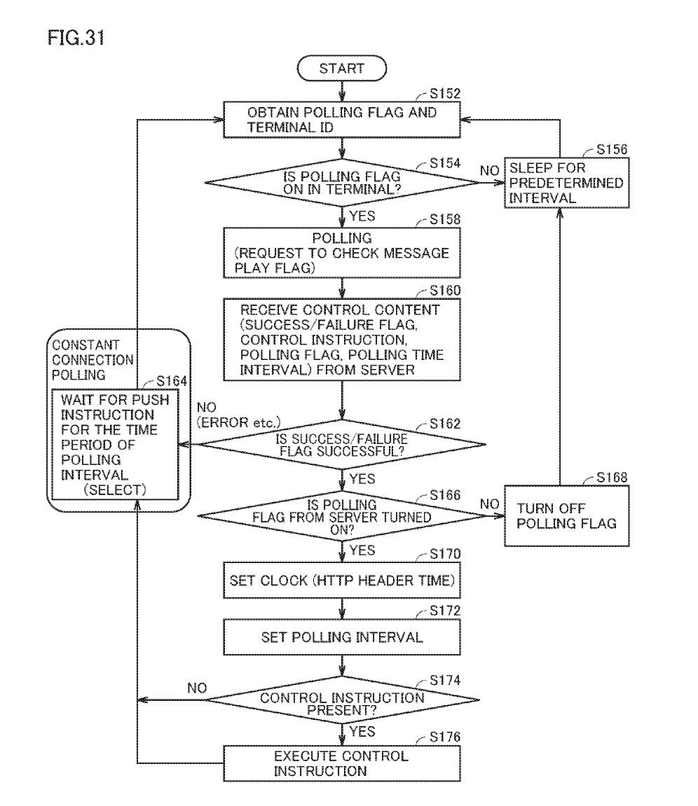

The CPU 110 controls each part of the client 100 by running programs stored in the memory 120 or in external storage media. More specifically, the CPU 110 operates as a client APP 110, and as a client API. In other words, the CPU 110 executes the programs stored in the memory 120, and performs the operation of the client 100 described in FIG. 15, and the processes of FIGS. 31, 34, 37, and 40 (step S).

The actual examples of the memory 120 are as described in First Embodiment, and will not be described.

The memory 120 stores programs run by the CPU 110, data generated after the execution of a program by the CPU 110, input data via the input/output unit 130, APP data operating as a client 100 such as the vacuum cleaner 100A, the air conditioner 100B, and the television 100C, and API data for communicating with external devices while exchanging data with the client APP. Specifically, the memory 120 stores information such as the connected device of the constant connection server, the connected device of the application server, service identification code, service authentication token, connection ID, and client identification ID.

The input/output unit 130, the camera 140, the home appliance control circuit 150, and the communication interface 160 are as described in First Embodiment, and will not be repeated.

The CPU 110 of the clients 100 (for example, the vacuum cleaner 100A, and the television 100C) compatible with the WebSocket protocol may make a constant connection with the constant connection server 200 via the communication interface 160, or may communicate with the application server 300 over the HTTP protocol via the communication interface 160. On the other hand, the CPU 110 of the clients 100 (for example, the air conditioner 100B) incompatible with the WebSocket protocol is unable to make a constant connection with the constant connection server 200, though communications with the application server 300 are possible over the HTTP protocol via the communication interface 160.

### <Hardware Configuration of Constant Connection Server 200>

An aspect of the hardware configuration of the constant connection server 200 is the same as the hardware configuration described for the constant connection server 200 of First Embodiment with reference to FIG. 12, and will not be described further. The CPU 210 executes the programs stored in the memory 220 to perform the operation of the constant connection server 200 described in FIG. 15.

### <Hardware Configuration of Application Server 300>

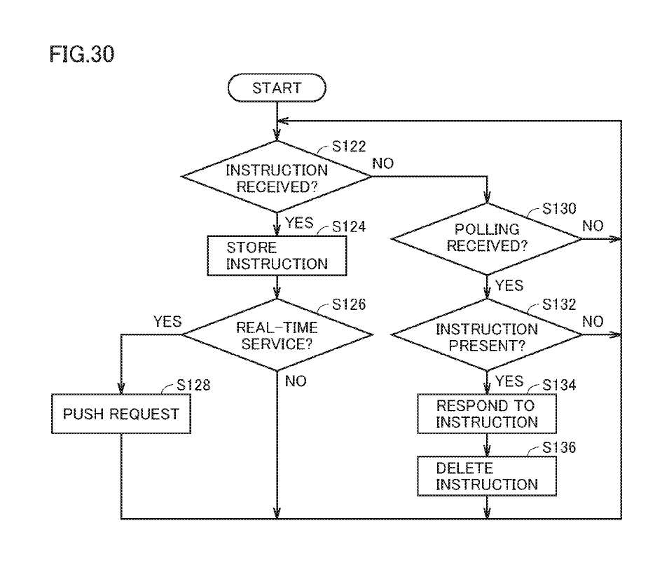

An aspect of the hardware configuration of the application server 300 is the same as the hardware configuration described for the application server 300 of First Embodiment with reference to FIG. 12, and will not be described further. The CPU 310 executes the programs stored in the memory 320 to perform the operation of the application server 300 described in FIG. 15, and the processes of FIGS. 30, 33, 36, and 39 (step S).

### <Hardware Configuration of Smartphone 500>

An aspect of the hardware configuration of communications devices such as the smartphone 500 and personal computers is the same as the hardware configuration of the smartphone 500 described in First Embodiment with reference to FIG. 14, and will not be described further.

<Data Exchange between Devices Concerning Constant Connection>

The data exchange between devices concerning the constant connection in the network system 1 according to the present embodiment is the same as that described in First Embodiment with reference to FIG. 15, and will not be described further.

The operation of the client 100 in FIG. 15 is realized by the client API 110A. Referring to FIGS. 11 and 15, the client API 110A is realized by the execution of a program by the CPU 110 of the client 100. The client API 110A communicates with the constant connection server 200 via the communication interface 160 over the WebSocket protocol. The client API 110A communicates with the constant connection server 200 and the application server 300 via the communication interface 160 over the HTTP protocol.

Similarly, the operation of the constant connection server 200 in FIG. 15 is realized by the WS server 210A. Referring to FIGS. 12 and 15, the WS server 210A is realized by the execution of a program by the CPU 210 of the constant connection server 200. The WS server 210A constantly connects to the client 100 via the communication interface 260 over the WebSocket protocol. The WS server 210A communicates with the application server 300 via the communication interface 260 over the HTTP protocol.

Similarly, the operation of the application server 300 in FIG. 15 is realized by the server API 310A. Referring to FIGS. 13 and 15, the server API 310A is realized by the execution of a program by the CPU 310 of the application server 300. The server API 310A communicates with the client 100, the constant connection server 200, and other communication devices such as the smartphone 500 via the communication interface 360 over the HTTP protocol.

### <Details of Application Server Procedures>

The following specifically describes the procedures of the application server 300 in the network system 1 according to the present embodiment. FIG. 30 is a flowchart representing details of the procedures of the application server 300 in the network system 1 according to the present embodiment.

Referring to FIG. 30, the CPU 310 of the application server 300 determines whether an instruction from other devices such as the smartphone 500 and a personal computer has been received via the communication interface 360 (step S122). If it is determined that an instruction has been received (YES in step S122), the CPU 310 stores in the memory 320 the client identification ID specifying the client 100 of interest to the instruction, together with the received instruction (step S124).

The CPU 310 determines the need to immediately pass the instruction to the client 100 (step S126). For example, the CPU 310 determines whether a predetermined immediate condition is satisfied. If it is determined that the instruction does not need to be passed immediately (NO in step S126), the CPU 310 repeats the procedures from step S122.

If it is determined that the instruction needs to be passed immediately (YES in step S126), the CPU 310 pushes a polling instruction to the client 100 via the constant connection server 200 by using the communication interface 360 (step S128). Specifically, the CPU 310 sends the connection ID specifying the client, and a polling instruction to the constant connection server 200.

If the instruction is not received (NO in step S122), the CPU 310 determines the presence or absence of polling from the client 100 via the communication interface 360 (step S130). In the absence of polling from the client 100 (NO in step S130), the CPU 310 repeats the procedures from step S122.

In the presence of polling from the client 100 (YES in step S130), the CPU 310 determines whether an instruction intended for the client 100 is stored in the memory 320 (step S132). If it is determined that an instruction intended for the client 100 is not stored in the memory 320 (NO in step S132), the CPU 310 repeats the procedures from step S122.

If it is determined that an instruction intended for the client 100 is stored in the memory 320 (YES in step S132), the CPU 310 sends the instruction to the client 100 via the communication interface 360 over the HTTP protocol (step S134). The CPU 310 deletes the instruction from the memory 320 (step S136). The CPU 310 repeats the procedures from step S122.

### <Details of Client Procedures>

The following specifically describes the procedures of the client 100 in the network system. 1 according to the present embodiment. FIG. 31 is a flowchart representing details of the procedures of the client 100 in the network system 1 according to the present embodiment.

Referring to FIG. 31, the CPU 110 of the client 100 reads a polling flag and a client identification ID from the memory 120 (step S152). The CPU 110, by referring to the memory 120, determines whether the polling flag is ON (step S154). When the polling flag is OFF (NO in step S154), the CPU 110 sleeps for a predetermined time period (step S156). The CPU 110 repeats the procedures from step S152.

When the polling flag is ON (YES in step S154), the CPU 110 polls the application server 300 via the communication interface 160 over the HTTP protocol (step S158). The CPU 110 receives control data from the application server 300 via the communication interface 160 (step S160). The control data contain information such as a success/failure flag indicative of the success or failure of polling, a control instruction, a polling flag, and a polling interval.

The CPU 110 determines whether the success flag is ON (step S162). When the success flag is OFF (NO in step S162), the CPU 110 waits for the polling instruction from the constant connection server 200 via the communication interface 160 for the time period of the polling interval (step S164).

Upon receiving the polling instruction from the constant connection server 200, the CPU 110 polls the application server 300 via the communication interface 160 over the HTTP protocol, and repeats the procedures from step S160. On the other hand, the CPU 110 repeats the procedures from step S152 when it does not receive the polling instruction from the constant connection server 200.

When the success flag is ON (YES in step S162), the CPU 110 determines whether the polling flag contained in the control data is ON (step S166). If it is determined that the polling flag contained in the control data is OFF (NO in step S166), the CPU 110 turns off the polling flag in the memory 120 (step S168). The CPU 110 repeats the procedures from step S156.

When the polling flag contained in the control data is ON (YES in step S166), the CPU 110 resets the clock (step S170). The CPU 110 updates the polling interval in the memory 120 with the polling interval contained in the control data (step S172).

The CPU 110 determines whether the control data contains a control instruction (step S174). The CPU 110 repeats the procedures from step S164 when the control data does not contain a control instruction (NO in step S174).

When the control data contains a control instruction (YES in step S174), the CPU 110 executes the control instruction (step S176). The CPU 110 repeats the procedures from step S164.

Instead of step S156, the CPU 110 may wait for the polling instruction from the constant connection server 200 for a predetermined time period (step S164). Specifically, the CPU 110 instead of step S156 may poll the application server 300 via the communication interface 160 over the HTTP protocol in response to the polling instruction from the constant connection server 200.

### Tenth Embodiment

The following Tenth Embodiment describes a network system 1 in which the client 100 is a vacuum cleaner 100A, and in which the application server 300 provides a message delivering service. Specifically, a network system 1 is described in which the user of the smartphone 500 uses the service that makes the vacuum cleaner 100A output the desired message. The overall configuration of the network system 1 according to the present embodiment is as described in Ninth Embodiment, and will not be described.

### <Brief Overview of Network System Operation>

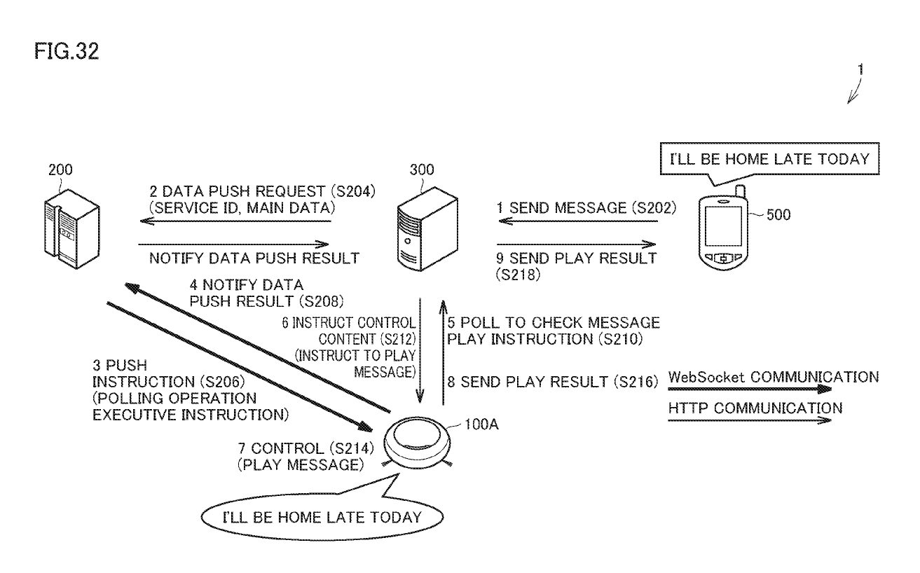

The following is a brief overview of the operation of the network system 1 according to the present embodiment. FIG. 32 is a schematic diagram briefly representing the overall configuration and operation of the network system 1 according to the present embodiment.

Referring to FIG. 32, the clients 100 (the vacuum cleaner 100A, the air conditioner 100B, and the television 100C) poll the application server 300 over the HTTP protocol on a regular basis. It should be noted, however, that the vacuum cleaner 100A and the television 100C, capable of making a constant connection with the constant connection server 200, do not necessarily require regular polling.

The smartphone 500 accepts entry of a message from the user. The smartphone 500 sends the application server 300 a message output instruction for the vacuum cleaner 100A (step S202). The message output instruction sent from the smartphone 500 contains text data representing a message.

The application server 300 sends a polling instruction to the vacuum cleaner 100A via the constant connection server 200 (step S204, step S206). Specifically, the application server 300 sends the constant connection server 200 a connection ID for specifying a combination of the vacuum cleaner 100A and the service for vacuum cleaner, together with the polling instruction (step S204).

The constant connection server 200, by using the connection ID, sends the polling instruction to the vacuum cleaner 100A over the WebSocket protocol (step S206).

By using the WebSocket protocol, the vacuum cleaner 100A notifies the constant connection server 200 of the receipt of the polling instruction (step S208). The vacuum cleaner 100A then polls the application server 300 over the HTTP protocol (step S210).

In response to the polling, the application server 300 converts the text data contained in the message output instruction into sound data. The application server 300 then sends the message output instruction containing the sound data to the vacuum cleaner 100A over the HTTP protocol (step S212).

The vacuum cleaner 100A outputs a sound message through a speaker in response to the message output instruction (step S214). The vacuum cleaner 100A may output the message on a display screen in response to the message output instruction. The vacuum cleaner 100A notifies the application server 300 of the receipt of the message output instruction, and the completion of the message output over the HTTP protocol (step S216).

The application server 300 notifies the smartphone 500 that the message output instruction has been received by the client 100, and that the client 100 has output the message (step S218). The smartphone 500 outputs the completion of the message output either on a display screen or through a speaker.

In this manner, in the present embodiment, the application server 300 can send service data to the vacuum cleaner 100A without having the need to wait for the regularly incoming polling from the vacuum cleaner 100A. Similarly, the application server 300 can send service data to the television 100C without having the need to wait for the regularly incoming polling from the television 100C.

For the air conditioner 100B and other home appliances (including other vacuum cleaners) that do not accommodate constant connection, the application server 300 can send service data to the air conditioner 100B or other home appliances in response to the polling from these devices, as typically performed in the art.

### <Hardware Configurations of Devices>

The hardware configurations of the client 100, the constant connection server 200, the application server 300, and the smartphone 500 are as described in Ninth Embodiment, and will not be described.

### <Data Exchange Between Devices Concerning Constant Connection>

The data exchange between devices concerning a constant connection in the network system 1 according to the present embodiment is as described in Ninth Embodiment, and will not be described.

### <Details of Application Server Procedures>

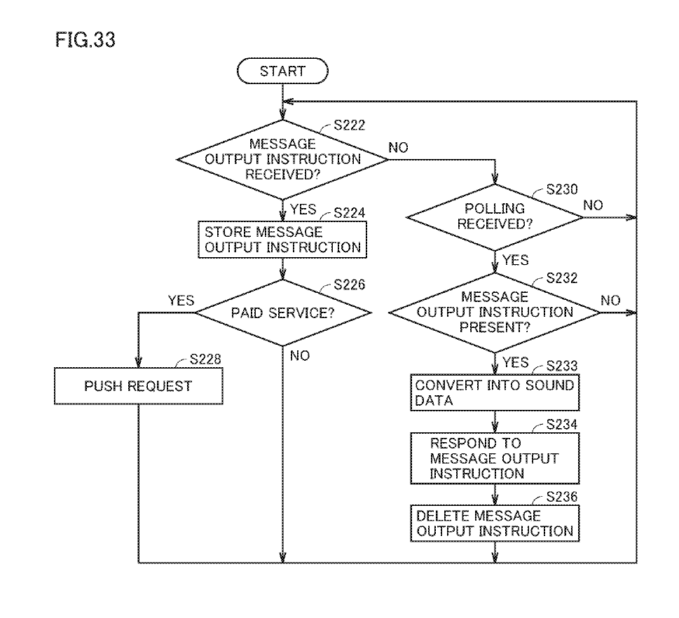

The following specifically describes the procedures of the application server 300 in the network system 1 according to the present embodiment. FIG. 33 is a flowchart representing details of the procedures of the application server 300 in the network system 1 according to the present embodiment.

Referring to FIG. 33, the CPU 310 of the application server 300 determines whether a message output instruction from the smartphone 500 has been received via the communication interface 360 (step S222). If it is determined that a message output instruction has been received from the smartphone 500 (YES in step S222), the CPU 310 stores in the memory 320 the client identification ID specifying the client 100 associated with the smartphone 500 or the user of the smartphone 500, together with the received message output instruction (step S224). The message output instruction contains text data representing a message.

The CPU 310 determines the need to immediately pass the message output instruction to the client 100 (step S226). Here, the CPU 310 determines whether the user of the smartphone 500 is a member of a paid service. If it is determined that the user of the smartphone 500 is not a member of a paid service (NO in step S226), the CPU 310 repeats the procedures from step S222.

If it is determined that the user of the smartphone 500 is a member of a paid service (YES in step S226), the CPU 310 pushes a polling instruction to the client 100 via the constant connection server 200 by using the communication interface 360 (step S228). Specifically, the CPU 310 sends a connection ID for specifying the client and the service, and the polling instruction to the constant connection server 200.

If the message output instruction is not received (NO in step S222), the CPU 310 determines the presence or absence of polling from the client 100 via the communication interface 360 (step S230). In the absence of polling from the client 100 (NO in step S230), the CPU 310 repeats the procedures from step S222.

In the presence of polling from the client 100 (YES in step S230), the CPU 310 determines whether a message output instruction for the client 100 is stored in the memory 320 (step S232). If it is determined that a message output instruction for the client 100 is not stored in the memory 320 (NO in step S232), the CPU 310 repeats the procedures from step S222.

If it is determined that a message output instruction for the client 100 is stored in the memory 320 (YES in step S232), the CPU 310 converts the text data contained in the message output instruction into sound data (step S233). The CPU 310 then sends the sound data to the client 100 via the communication interface 360 over the HTTP protocol (step S234). The CPU 310 deletes the message output instruction from the memory 320 (step S236). The CPU 310 repeats the procedures from step S222.

### <Details of Client Procedures>

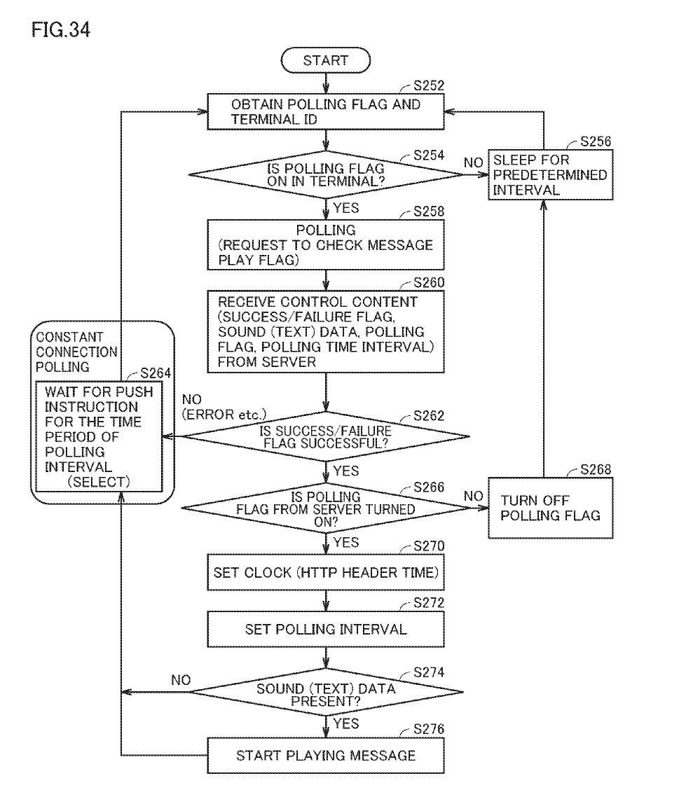

The following specifically describes the procedures of the client 100 in the network system 1 according to the present embodiment. FIG. 34 is a flowchart representing details of the procedures of the client 100 in the network system 1 according to the present embodiment.

Referring to FIG. 34, the CPU 110 of the client 100 reads a polling flag and a client identification ID from the memory 120 (step S252). The CPU 110, by referring to the memory 120, determines whether the polling flag is ON (step S254). When the polling flag is OFF (NO in step S254), the CPU 110 sleeps for a predetermined time period (step S256). The CPU 110 repeats the procedures from step S252.

When the polling flag is ON (YES in step S254), the CPU 110 polls the application server 300 via the communication interface 160 over the HTTP protocol (step S258). The CPU 110 receives control data from the application server 300 via the communication interface 160 (step S260). The control data contain information such as a success/failure flag indicative of the success or failure of polling, sound data, a polling flag, and a polling interval.

The CPU 110 determines whether the success flag is ON (step S262). When the success flag is OFF (NO in step S262), the CPU 110 waits for the polling instruction from the constant connection server 200 via the communication interface 160 for the time period of the polling interval (step S264).

Upon receiving the polling instruction from the constant connection server 200, the CPU 110 polls the application server 300 via the communication interface 160 over the HTTP protocol, and repeats the procedures from step S260. On the other hand, the CPU 110 repeats the procedures from step S252 when it does not receive the polling instruction from the constant connection server 200.

When the success flag is ON (YES in step S262), the CPU 110 determines whether the polling flag contained in the control data is ON (step S266). If it is determined that the polling flag contained in the control data is OFF (NO in step S266), the CPU 110 turns off the polling flag in the memory 120 (step S268). The CPU 110 repeats the procedures from step S256.

When the polling flag contained in the control data is ON (YES in step S266), the CPU 110 resets the clock (step S270). The CPU 110 updates the polling interval in the memory 120 with the polling interval contained in the control data (step S272).

The CPU 110 determines whether the control data contains sound data (step S274). The CPU 110 repeats the procedures from step S264 when the control data does not contain sound data (NO in step S274).

When the control data contains sound data (YES in step S274), the CPU 110 outputs a sound message through a speaker provided as the input/output unit 130 (step S276). The CPU 110 repeats the procedures from step S264.

Instead of step S256, the CPU 110 may wait for the polling instruction from the constant connection server 200 for a predetermined time period (step S264). Specifically, the CPU 110 instead of step S256 may poll the application server 300 via the communication interface 160 over the HTTP protocol in response to the polling instruction from the constant connection server 200.

### Eleventh Embodiment

The following Eleventh Embodiment describes a network system 1 in which the client 100 is a vacuum cleaner 100A, and in which the application server 300 provides an indoor photography service. Specifically, a network system 1 is described in which the user of the smartphone 500 uses the service that makes the vacuum cleaner 100A take pictures or videos in a room. The overall configuration of the network system 1 according to the present embodiment is as described in Ninth Embodiment, and will not be described.

### <Brief Overview of Network System Operation>

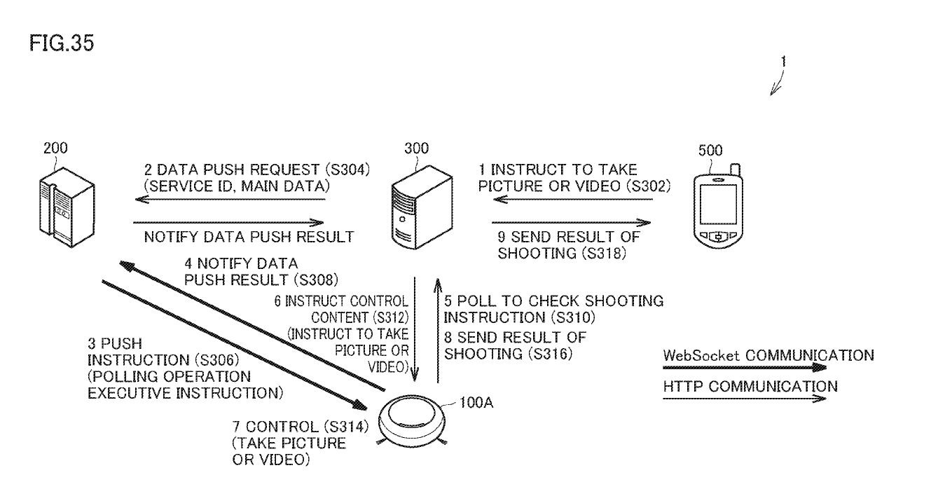

The following is a brief overview of the operation of the network system 1 according to the present embodiment. FIG. 35 is a schematic diagram briefly representing the overall configuration and operation of the network system 1 according to the present embodiment.

Referring to FIG. 35, the clients 100 (the vacuum cleaner 100A, the air conditioner 100B, and the television 100C) each poll the application server 300 over the HTTP protocol on a regular basis. It should be noted, however, that the vacuum cleaner 100A and the television 100C, capable of making a constant connection with the constant connection server 200, do not necessarily require regular polling.

The smartphone 500 sends the application server 300 a shooting instruction for the vacuum cleaner 100A (step S302).

The application server 300 sends a polling instruction to the vacuum cleaner 100A via the constant connection server 200 (step S304, step S306). Specifically, the application server 300 sends the constant connection server 200 a connection ID for specifying a combination of the vacuum cleaner 100A and the service for vacuum cleaner, together with the polling instruction (step S304). The constant connection server 200, by using the connection ID, sends the polling instruction to the vacuum cleaner 100A over the WebSocket protocol (step S306).

By using the WebSocket protocol, the vacuum cleaner 100A notifies the constant connection server 200 of the receipt of the polling instruction (step S308). The vacuum cleaner 100A then polls the application server 300 over the HTTP protocol (step S310).

In response to the polling, the application server 300 sends the shooting instruction to the vacuum cleaner over the HTTP protocol (step S312).

The vacuum cleaner takes a picture or a video in a room in response to the shooting instruction (step S314). The vacuum cleaner sends the application server 300 a notification of the receipt of the shooting instruction, a notification of the completion of the picture or video shooting, picture data, and video data over the HTTP protocol (step S316).

The application server 300 sends a notification of the receipt of the shooting instruction by the client 100, a notification of the completion of the picture or video shooting, the picture data, and the video data to the smartphone 500 (step S318). The smartphone 500 outputs the completion of the message output either on a display screen or through a speaker.

In this manner, in the present embodiment, the application server 300 can send service data to the vacuum cleaner 100A without having the need to wait for the regularly incoming polling from the vacuum cleaner 100A. Similarly, the application server 300 can send service data to the television 100C without having the need to wait for the regularly incoming polling from the television 100C.

For the air conditioner 100B and other home appliances (including other vacuum cleaners) that do not accommodate constant connection, the application server 300 can send service data to the air conditioner 100B or other home appliances in response to the polling from these devices, as typically performed in the art.

### <Hardware Configurations of Devices>

The hardware configurations of the client 100, the constant connection server 200, the application server 300, and the smartphone 500 are as described in Ninth Embodiment, and will not be described.

### <Data Exchange Between Devices Concerning Constant Connection>

The data exchange between devices concerning a constant connection in the network system 1 according to the present embodiment is as described in Ninth Embodiment, and will not be described.

### <Details of Application Server Procedures>

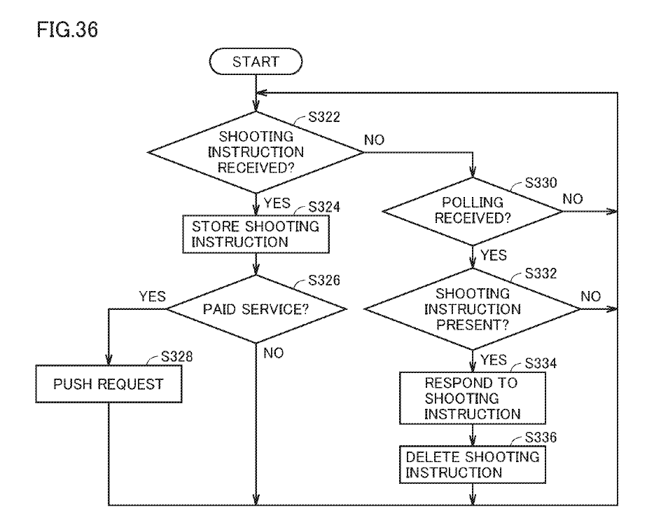

The following specifically describes the procedures of the application server 300 in the network system 1 according to the present embodiment. FIG. 36 is a flowchart representing details of the procedures of the application server 300 in the network system 1 according to the present embodiment.

Referring to FIG. 36, the CPU 310 of the application server 300 determines whether a shooting instruction from the smartphone 500 has been received via the communication interface 360 (step S322). The shooting instruction may be a shooting instruction for pictures, or a shooting instruction for videos. If it is determined that a shooting instruction has been received from the smartphone 500 (YES in step S322), the CPU 310 stores in the memory 320 the client identification ID specifying the client 100 associated with the smartphone 500, together with the received shooting instruction (step S324).

The CPU 310 determines the need to immediately pass the shooting instruction to the client 100 (step S326). Here, the CPU 310 determines whether the user of the smartphone 500 is a member of a paid service. If it is determined that the user of the smartphone 500 is not a member of a paid service (NO in step S326), the CPU 310 repeats the procedures from step S322.

If it is determined that the user of the smartphone 500 is a member of a paid service (YES in step S326), the CPU 310 pushes a polling instruction to the client 100 via the constant connection server 200 by using the communication interface 360 (step S328). Specifically, the CPU 310 sends a connection ID for specifying the client, and the polling instruction to the constant connection server 200.

If the shooting instruction is not received (NO in step S322), the CPU 310 determines the presence or absence of polling from the client 100 via the communication interface 360 (step S330). In the absence of polling from the client 100 (NO in step S330), the CPU 310 repeats the procedures from step S322.

In the presence of polling from the client 100 (YES in step S330), the CPU 310 determines whether a shooting instruction for the client 100 is stored in the memory 320 (step S332). If it is determined that a shooting instruction for the client 100 is not stored in the memory 320 (NO in step S332), the CPU 310 repeats the procedures from step S322.

If it is determined that a shooting instruction for the client 100 is stored in the memory 320 (YES in step S332), the CPU 310 sends the shooting instruction to the client 100 via the communication interface 360 over the HTTP protocol (step S334). The CPU 310 deletes the shooting instruction from the memory 320 (step S336). The CPU 310 repeats the procedures from step S322.

### <Details of Client Procedures>

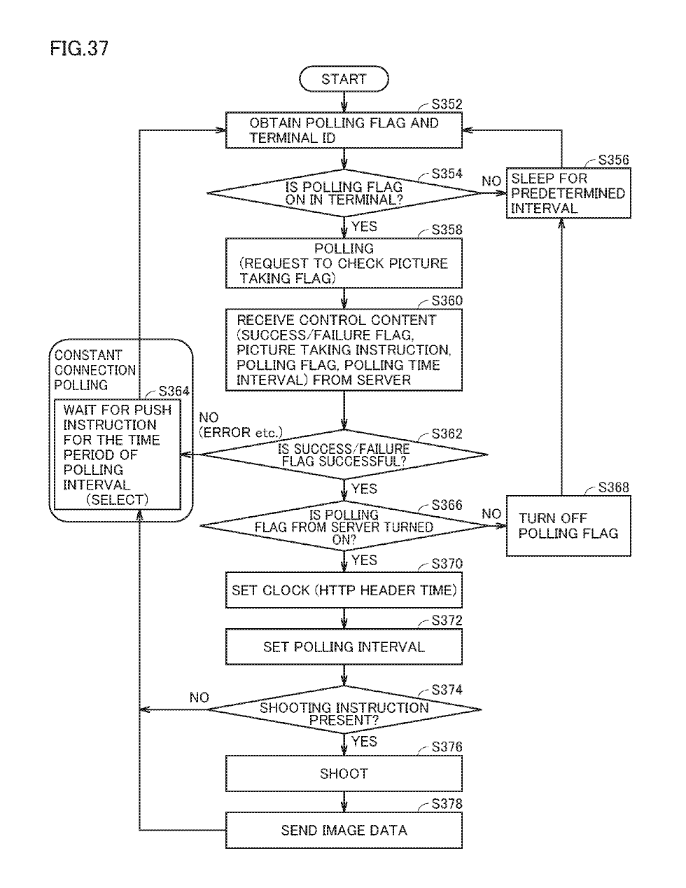

The following specifically describes the procedures of the client 100 in the network system 1 according to the present embodiment. FIG. 37 is a flowchart representing details of the procedures of the client 100 in the network system 1 according to the present embodiment.

Referring to FIG. 37, the CPU 110 of the client 100 reads a polling flag and a client identification ID from the memory 120 (step S352). The CPU 110, by referring to the memory 120, determines whether the polling flag is ON (step S354). When the polling flag is OFF (NO in step S354), the CPU 110 sleeps for a predetermined time period (step S356). The CPU 110 repeats the procedures from step S352.

When the polling flag is ON (YES in step S354), the CPU 110 polls the application server 300 via the communication interface 160 over the HTTP protocol (step S358). The CPU 110 receives control data from the application server 300 via the communication interface 160 (step S360). The control data contain information such as a success/failure flag indicative of the success or failure of polling, a shooting instruction, a polling flag, and a polling interval.

The CPU 110 determines whether the success flag is ON (step S362). When the success flag is OFF (NO in step S362), the CPU 110 waits for the polling instruction from the constant connection server 200 via the communication interface 160 for the time period of the polling interval (step S364).

Upon receiving the polling instruction from the constant connection server 200, the CPU 110 polls the application server 300 via the communication interface 160 over the HTTP protocol, and repeats the procedures from step S360. On the other hand, the CPU 110 repeats the procedures from step S352 when it does not receive the polling instruction from the constant connection server 200.

When the success flag is ON (YES in step S362), the CPU 110 determines whether the polling flag contained in the control data is ON (step S366). If it is determined that the polling flag contained in the control data is OFF (NO in step S366), the CPU 110 turns off the polling flag in the memory 120 (step S368). The CPU 110 repeats the procedures from step S356.

When the polling flag contained in the control data is ON (YES in step S366), the CPU 110 resets the clock (step S370). The CPU 110 updates the polling interval in the memory 120 with the polling interval contained in the control data (step S372).

The CPU 110 determines whether the control data contains a shooting instruction (step S374). The CPU 110 repeats the procedures from step S364 when the control data does not contain a shooting instruction (NO in step S374).

When the control data contains a shooting instruction (YES in step S374), the CPU 110 makes the camera 140 take a picture or a video (step S376). The CPU 110 then sends the picture data or video data to the application server 300 via the communication interface 160 over the HTTP protocol (step S378). The CPU 110 repeats the procedures from step S364.

Instead of step S356, the CPU 110 may wait for the polling instruction from the constant connection server 200 for a predetermined time period (step S364). Specifically, the CPU 110 instead of step S356 may poll the application server 300 via the communication interface 160 over the HTTP protocol in response to the polling instruction from the constant connection server 200.

### Twelfth Embodiment

The following Twelfth Embodiment describes a network system 1 in which the client 100 is a television 100C or a hard disk recorder, and in which the application server 300 provides a recording instruction relay service. Specifically, a network system 1 is described in which the user of the smartphone 500 uses the service that makes the television 100C record a television program. The overall configuration of the network system 1 according to the present embodiment is as described in Ninth Embodiment, and will not be described.

### <Brief Overview of Network System Operation>

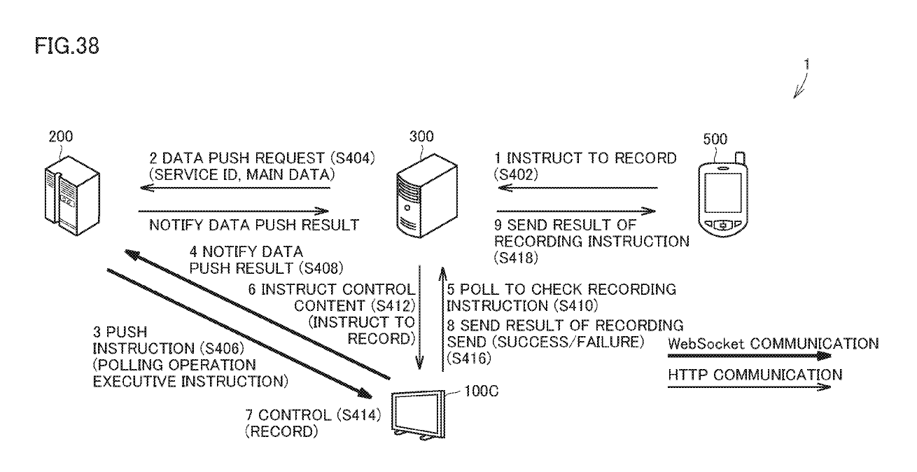

The following is a brief overview of the operation of the network system 1 according to the present embodiment. FIG. 38 is a schematic diagram briefly representing the overall configuration and operation of the network system 1 according to the present embodiment.

Referring to FIG. 38, the clients 100 (the vacuum cleaner 100A, the air conditioner 100B, and the television 100C) poll the application server 300 over the HTTP protocol on a regular basis. It should be noted, however, that the vacuum cleaner 100A and the television 100C, capable of making a constant connection with the constant connection server 200, do not necessarily require regular polling.

The smartphone 500 accepts entry of a recording instruction from the user. The smartphone 500 sends the recording instruction for the television 100C to the application server 300 (step S402).

The application server 300 sends a polling instruction to the television 100C via the constant connection server 200 (step S404, step S406). Specifically, the application server 300 sends the constant connection server 200 a connection ID for specifying a combination of the television 100C and the service for television, together with the polling instruction (step S404).

The constant connection server 200, by using the connection ID, sends the polling instruction to the television 100C over the WebSocket protocol (step S406).

By using the WebSocket protocol, the television 100C notifies the constant connection server 200 of the receipt of the polling instruction (step S408). The television 100C then polls the application server 300 over the HTTP protocol (step S410).

In response to the polling, the application server 300 sends the recording instruction to the television 100C over the HTTP protocol (step S412).

The television 100C records a television program or sets the timer for recording according to the recording instruction (step S414). The television 100C notifies the application server 300 of the receipt of the recording instruction or the completion of recording over the HTTP protocol (step S416).

The application server 300 notifies the smartphone 500 that the client 100 has received the recording instruction or finished recording (step S418). The smartphone 500 outputs the receipt of the recording instruction either on a display screen or through a speaker.

In this manner, in the present embodiment, the application server 300 can send service data to the television 100C without having the need to wait for the regularly incoming polling from the television 100C. Similarly, the application server 300 can send service data to the vacuum cleaner 100A without having the need to wait for the regularly incoming polling from the vacuum cleaner 100A.

For the air conditioner 100B and other home appliances that do not accommodate constant connection, the application server 300 can send service data to the air conditioner 100B or other home appliances in response to the polling from these devices, as typically performed in the art.

### <Hardware Configurations of Devices>

The hardware configurations of the client 100, the constant connection server 200, the application server 300, and the smartphone 500 are as described in Ninth Embodiment, and will not be described.

### <Data Exchange Between Devices Concerning Constant Connection>

The data exchange between devices concerning a constant connection in the network system 1 according to the present embodiment is as described in Ninth Embodiment, and will not be described.

### <Details of Application Server Procedures>

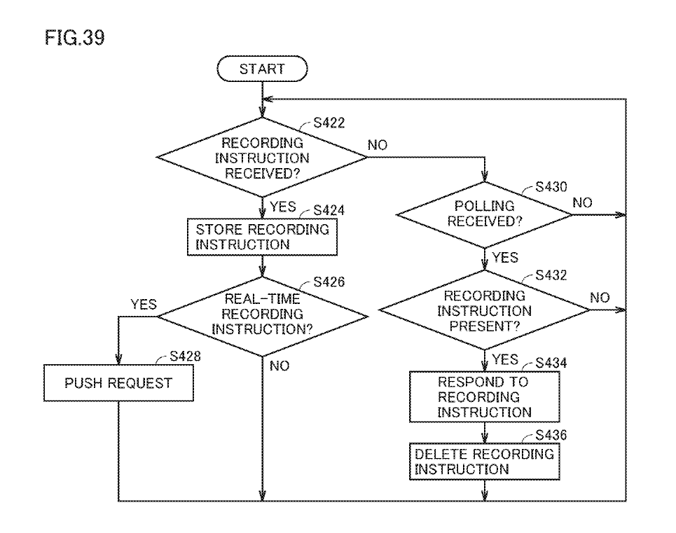

The following specifically describes the procedures of the application server 300 in the network system 1 according to the present embodiment. FIG. 39 is a flowchart representing details of the procedures of the application server 300 in the network system 1 according to the present embodiment.

Referring to FIG. 39, the CPU 310 of the application server 300 determines whether a recording instruction from the smartphone 500 has been received via the communication interface 360 (step S422). The recording instruction may be a timer recording instruction, or a real-time recording instruction. The recording instruction contains information such as recording date, start time of recording, end time of recording, and channel. The recording instruction may contain a flag for immediately starting recording irrespective of the start time.

If it is determined that a recording instruction has been received from the smartphone 500 (YES in step S422), the CPU 310 stores in the memory 320 the client identification ID specifying the client 100 associated with the smartphone 500 or the user of the smartphone 500, together with the received recording instruction (step S424).

The CPU 310 determines the need to immediately pass the recording instruction to the client 100 (step S426). Here, the CPU 310 determines whether the recording instruction is a real-time recording instruction. For example, the CPU 110 determines whether the current time is past the start time of recording. Alternatively, the CPU 110 determines whether the flag for immediately starting recording is ON in the recording instruction.

The CPU 310 repeats the procedures from step S422 if it is determined that the recording instruction is a timer recording instruction, specifically when the current time is before the start time of recording, or when the flag for immediately starting recording is OFF in the recording instruction (NO in step S426).

The CPU 310 pushes a polling instruction to the client 100 via the constant connection server 200 by using the communication interface 360 (step S428) when the recording instruction is a real-time recording instruction, specifically when the current time is past the start time of recording, or when the flag for immediately starting recording is ON in the recording instruction (YES in step S426). Specifically, the CPU 310 sends a connection ID for specifying the client, and the polling instruction to the constant connection server 200.

If the recording instruction is not received (NO in step S422), the CPU 310 determines the presence or absence of polling from the client 100 via the communication interface 360 (step S430). In the absence of polling from the client 100 (NO in step S430), the CPU 310 repeats the procedures from step S422.

In the presence of polling from the client 100 (YES in step S430), the CPU 310 determines whether a recording instruction for the client 100 is stored in the memory 320 (step S432). If it is determined that a recording instruction for the client 100 is not stored in the memory 320 (NO in step S432), the CPU 310 repeats the procedures from step S422.

If it is determined that a recording instruction for the television 100C is stored in the memory 320 (YES in step S432), the CPU 310 sends the recording instruction to the television 100C via the communication interface 360 over the HTTP protocol (step S434). The CPU 310 deletes the recording instruction from the memory 320 (step S436). The CPU 310 repeats the procedures from step S422.

### <Details of Client Procedures>

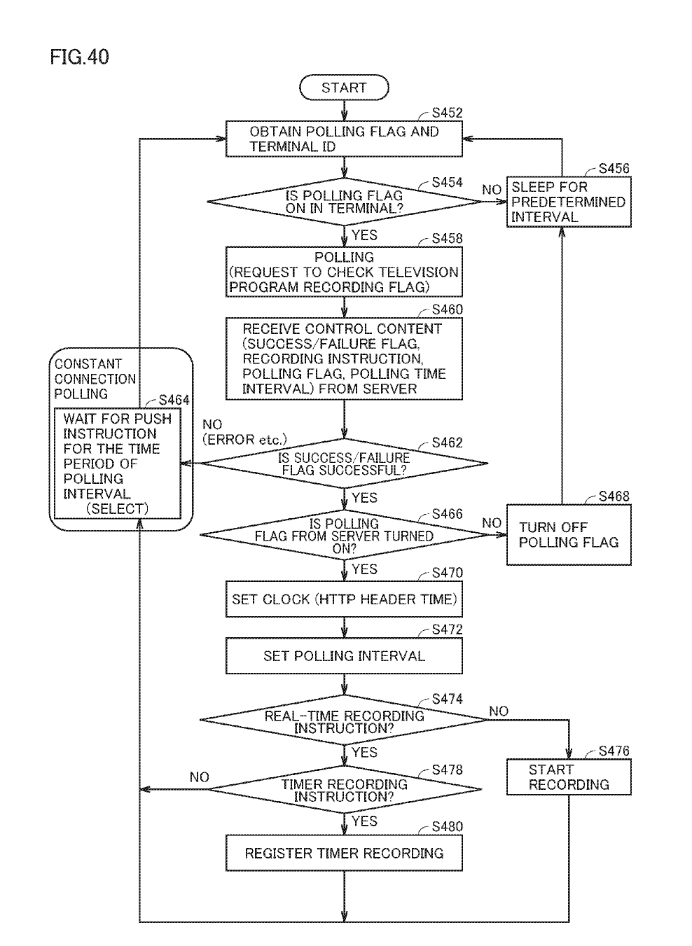

The following specifically describes the procedures of the television 100C in the network system 1 according to the present embodiment. FIG. 40 is a flowchart representing details of the procedures of the television 100C in the network system 1 according to the present embodiment.

Referring to FIG. 40, the CPU 110 of the client 100 reads a polling flag and a client identification ID from the memory 120 (step S452). The CPU 110, by referring to the memory 120, determines whether the polling flag is ON (step S454). When the polling flag is OFF (NO in step S454), the CPU 110 sleeps for a predetermined time period (step S456). The CPU 110 repeats the procedures from step S452.

When the polling flag is ON (YES in step S454), the CPU 110 polls the application server 300 via the communication interface 160 over the HTTP protocol (step S458). The CPU 110 receives control data from the application server 300 via the communication interface 160 (step S460). The control data contain information such as a success/failure flag indicative of the success or failure of polling, a recording instruction, a polling flag, and a polling interval.

The CPU 110 determines whether the success flag is ON (step S462). When the success flag is OFF (NO in step S462), the CPU 110 waits for the polling instruction from the constant connection server 200 via the communication interface 160 for the time period of the polling interval (step S464).

Upon receiving the polling instruction from the constant connection server 200, the CPU 110 polls the application server 300 via the communication interface 160 over the HTTP protocol, and repeats the procedures from step S460. On the other hand, the CPU 110 repeats the procedures from step S452 when it does not receive the polling instruction from the constant connection server 200.

When the success flag is ON (YES in step S462), the CPU 110 determines whether the polling flag contained in the control data is ON (step S466). If it is determined that the polling flag contained in the control data is OFF (NO in step S466), the CPU 110 turns off the polling flag in the memory 120 (step S468). The CPU 110 repeats the procedures from step S456.

When the polling flag contained in the control data is ON (YES in step S466), the CPU 110 resets the clock (step S470). The CPU 110 updates the polling interval in the memory 120 with the polling interval contained in the control data (step S472).

The CPU 110 determines whether the control data contains a real-time recording instruction (step S474). The CPU 110 repeats the procedures from step S464 when the control data does not contain a real-time recording instruction (NO in step S474).

When the control data contains a real-time recording instruction (YES in step S474), the CPU 110 starts recording the channel contained in the real-time recording instruction (step S476). The CPU 110 repeats the procedures from step S464.

When the control data does not contain a real-time recording instruction (NO in step S474), the CPU 110 determines whether the control data contains a timer recording instruction (step S478). If it is determined that the control data contains a timer recording instruction (YES in step S478), the CPU 110 registers the timer recording in the memory 120 (step S480). The CPU 110 repeats the procedures from step S464.

The CPU 110 repeats the procedures from step S464 when the control data does not contain a timer recording instruction.

Instead of step S456, the CPU 110 may wait for the polling instruction from the constant connection server 200 for a predetermined time period (step S464). Specifically, the CPU 110 instead of step S456 may poll the application server 300 via the communication interface 160 over the HTTP protocol in response to the polling instruction from the constant connection server 200.

### Thirteenth Embodiment

In the foregoing Eleventh Embodiment, the application server 300 determines whether to send a polling instruction to the client 100 on the basis of whether the service is a paid service or a free service. However, the application server 300 may determine whether to send a polling instruction to the client 100 on the basis of whether an instruction for real-time picture or video shooting, or an instruction for timer shooting has been received, as in Twelfth Embodiment.

Specifically, the CPU 310 of the application server 300 in step S326 of FIG. 36 may determine whether a real-time shooting instruction has been received, as in step S426 of FIG. 39. When the real-time shooting instruction is received (YES in step S326), the CPU 310 pushes the polling instruction to the client 100 via the constant connection server 200 by using the communication interface 360 (step S328). On the other hand, the CPU 310 repeats the procedures from step S322 when the real-time shooting instruction is not received (NO in step S326), specifically when an instruction for timer shooting (including information such as start time of shooting, and/or a shooting cycle of regular shooting) is received.

Similarly, the CPU 110 in steps S374 to S378 of FIG. 37 determines whether the control data contains a real-time shooting instruction, as in steps S474 to S480 of FIG. 40. If it is determined that the control data contains a real-time shooting instruction, the CPU 110 takes a video or a picture with the camera 140 according to the real-time shooting instruction.

The CPU 110 determines whether the control data contains an instruction for timer shooting when the control data does not contain a real-time shooting instruction. When the control data contains an instruction for timer shooting, the CPU 110 registers the instruction for timer shooting in the memory 120. The CPU 110 repeats the procedures from step S364 when the control data does not contain an instruction for timer shooting.

### Fourteenth Embodiment

In the foregoing Tenth Embodiment, the application server 300 converts text data into sound data. However, the conversion from text data into sound data may be performed by the client 100.

Specifically, the application server 300 sends text data to the client 100 in response to the polling from the client 100. The client 100 then converts the text data into sound data. By using the sound data, the client 100 outputs a message through a speaker.

In this way, the application server 300 does not need to send sound data to the client 100, and the communication data volume can be reduced.

### Fifteenth Embodiment

In the foregoing Tenth Embodiment, the client 100 outputs a sound message through a speaker. However, the client 100 may display a message on a display screen.

Specifically, the application server 300 sends text data to the client 100 in response to the polling from the client 100. The client 100 then displays a message on a display screen by using the text data.

### Sixteenth Embodiment

In the foregoing Tenth Embodiment, the client 100 outputs a sound message through a speaker. However, the client 100 may display a message on a display screen, together with the sound message through a speaker.

Specifically, the application server 300 converts text data into sound data in response to the polling from the client 100. The application server 300 then sends the text data and the sound data to the client 100. The client 100 displays a message on a display screen by using the text data, and outputs sound based on the sound data through a speaker.

The client 100 may convert text data into sound data in Sixteenth Embodiment, as in Fourteenth Embodiment. In this way, the application server 300 does not need to send sound data to the client 100, and the communication data volume can be reduced.

### <Examples of Other Applications>

As is evident, the present invention also can be achieved by supplying a program to a system or a device. The advantages of the present invention also can be obtained with a computer (or a CPU or an MPU) in a system or a device upon the computer reading and executing the program code stored in the supplied storage medium (or memory) storing software programs intended to realize the present invention.

In this case, the program code itself read from the storage medium realizes the functions of the embodiments above, and the storage medium storing the program code constitutes the present invention.

Evidently, the functions of the embodiments above can be realized not only by a computer reading and executing such program code, but by some or all of the actual processes performed by the OS (operating system) or the like running on a computer under the instructions of the program code.

The functions of the embodiments above also can be realized by some or all of the actual processes performed by the CPU or the like of an expansion board or expansion unit under the instructions of the program code read from a storage medium and written into other storage medium provided in the expansion board inserted into a computer or the expansion unit connected to a computer.

The embodiments disclosed herein are to be considered in all aspects only as illustrative and not restrictive. The scope of the present invention is to be determined by the scope of the appended claims, not by the foregoing descriptions, and the invention is intended to cover all modifications falling within the equivalent meaning and scope of the scope of the claims set forth below.

What is claimed is:

1. A network system comprising:
a first electronic device; and
a second electronic device,
wherein the first electronic device and the second electronic device perform data communications by using a first protocol that enables a constant connection, and perform data communications by using a second protocol when a predetermined condition is satisfied.

2. The network system according to claim 1, wherein the first electronic device is a server, and the second electronic device is a client,
wherein the server determines whether the predetermined condition is satisfied for sending of data to the client.

3. The network system according to claim 2,
wherein the server sends the client information indicative of a storage location of sending data by using the first protocol when the predetermined condition is satisfied, and
wherein the client downloads the data from the storage location by using the second protocol.

4. The network system according to claim 3,
wherein the server by using the first protocol sends the client a transaction ID for specifying sending of data to the client,
wherein the client sends the transaction ID to the server when downloading the data from the storage location, and
wherein the server by using the transaction ID notifies a different server of the completion of the download.

5. The network system according to claim 1, wherein the first electronic device is a server, and the second electronic device is a client,
wherein the client determines whether the predetermined condition is satisfied for sending of data to the server.

6. The network system according to claim 5,
wherein the client receives information indicative of a destination of the data from the server by using the first protocol, and uploads the data to the destination by using the second protocol when the predetermined condition is satisfied.

7. The network system according to claim 5,
wherein the client by using the first protocol sends the server a transaction ID for specifying sending of the data to the server,
wherein the client sends the transaction ID to the server when uploading the data to the destination, and
wherein the server by using the transaction ID notifies a different server of the completion of the upload.

8. The network system according to claim 1, wherein the predetermined condition is satisfied when the size of transmitted data is above a predetermined value.

9. The network system according to claim 1, wherein the predetermined condition is satisfied when a communication speed is below a predetermined value.

10. The network system according to claim 1, wherein the predetermined condition is satisfied when the time required for sending data is above a predetermined value.

11. The network system according to claim 1, wherein the predetermined condition is satisfied when the frequency of data transmission and/or reception over the first protocol is above a predetermined value.

12. A constant connection method comprising:
a first and a second electronic device performing data communications over a first protocol that enables a constant connection;
either of the first and second electronic devices determining whether a predetermined condition is satisfied; and
the first and second electronic devices performing data communications over a second protocol when the predetermined condition is satisfied.

13. An electronic device comprising:
a communication interface;
a memory that stores a predetermined condition; and
a processor that performs data communications via the communication interface by using a first protocol that enables a constant connection, and that perform data communications via the communication interface by using a second protocol when the predetermined condition is satisfied.

14. A network system comprising:
an electronic device;
a constant connection server that makes a constant connection with the electronic device; and
an application server that sends data to the electronic device in response to polling from the electronic device,
wherein the application server pushes a polling instruction to the electronic device via the constant connection server.

15. The network system according to claim 14,
wherein the application server determines whether to push the polling instruction to the electronic device via the constant connection server according to a type of a received instruction.

16. The network system according to claim 14,
wherein the application server pushes the polling instruction to the electronic device via the constant connection server when in receipt of an incoming instruction for immediately starting recording, and
wherein the application server waits for polling from the electronic device without pushing the polling instruction when in receipt of an incoming instruction for timer recording.

17. The network system according to claim 14,
wherein the application server pushes the polling instruction to the electronic device via the constant connection server when in receipt of an incoming instruction for immediately starting shooting of a picture or a video, and
wherein the application server waits for polling from the electronic device without pushing the polling instruction when in receipt of an incoming instruction for timer shooting of a picture or a video.

18. The network system according to claim 14,
wherein the application server pushes the polling instruction to the electronic device via the constant connection server when sending data concerning a paid service, and
wherein the application server waits for polling from the electronic device without pushing the polling instruction when sending data concerning a free service.

19. The network system according to claim 14,
wherein the application server pushes the polling instruction to the electronic device via the constant connection server when in receipt of an incoming message from a different electronic device, and
wherein the electronic device polls the application server and receives the message, and outputs the message.

20. The network system according to claim 14, wherein the electronic device includes a camera,
wherein the application server pushes the polling instruction to the electronic device via the constant connection server when in receipt of an incoming instruction from a different electronic device, and
wherein the electronic device polls the application server and receives a shooting instruction from the application server, and takes a picture or a video with the camera.

21. The network system according to claim 14, wherein the electronic device has a television program recording function,
wherein the application server pushes the polling instruction to the electronic device via the constant connection server when in receipt of an incoming instruction from a different electronic device, and
wherein the electronic device polls the application server and receives a recording instruction from the application server, and records a television program.

22. A communication method comprising:
an electronic device opening a constant connection with a constant connection server;
an application server pushing a polling instruction to the electronic device via the constant connection server;
the electronic device polling the application server; and
the application server sending data to the electronic device in response to the polling.

23. An electronic device comprising:
a communication interface provided for a constant connection with a constant connection server, and for data communications with the application server; and
a processor that, by using the communication interface, receives a polling instruction from the constant connection server, and polls the application server and receives data from the application server.

24. An application server comprising:
a communication interface provided for communications with a constant connection server and an electronic device; and
a processor that, by using the communication interface, pushes a polling instruction to the electronic device via the constant connection server, and sends data to the electronic device in response to polling from the electronic device.
